(19) United States
(12) Patent Application Publication
(10) Pub. No.: US 2020/0024373 A1
(43) Pub. Date: Jan. 23, 2020

(54) MACRO-RAFT CHAIN TRANSFER AGENTS AS ANIONIC POLYMERIZATION TERMINATORS

(71) Applicant: IOWA STATE UNIVERSITY RESEARCH FOUNDATION, INC., Ames, IA (US)

(72) Inventors: Nacu Hernandez, Ames, IA (US); Eric Cochran, Ames, IA (US); Ronald Christopher Williams, Ames, IA (US); Michael John Forrester, Ames, IA (US); William Bradley, Ames, IA (US); George Kraus, Ames, IA (US)

(21) Appl. No.: 16/498,752

(22) PCT Filed: Mar. 27, 2018
(86) PCT No.: PCT/US2018/024472

§ 371 Date: Sep. 27, 2019

Related U.S. Application Data
(60) Provisional application No. 62/477,314, filed on Mar. 27, 2017.

(51) Int. Cl. C08F 2/38; C08F 112/14; C08F 293/00

(52) U.S. Cl. CPC C08F 2/38; C08F 2438/03; C08F 293/005; C08F 112/14

(57) ABSTRACT

The present invention relates to a compound of Formula (I): where \textcircled{P} R, R¹, R², R³, and Z are as described herein and to a process for preparing a compound of Formula (I). This invention also relates to a process for the synthesis of a polymer which includes providing a monomer composition, providing a compound of Formula (I), and polymerizing monomers within the monomer composition through controlled free radical polymerization with the compound of Formula (I) to form the polymer.

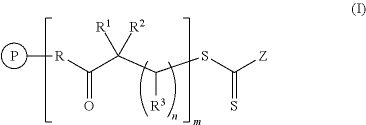

This application claims the benefit of U.S. Provisional Patent Application Ser. No. 62/477,314, filed Mar. 27, 2017, which is hereby incorporated by reference in its entirety.

### FIELD OF THE INVENTION

The present invention relates to macro-RAFT chain transfer agents as anionic polymerization terminators and methods of making and using them.

### BACKGROUND OF THE INVENTION

Anionic polymerization has been used industrially since the mid 20th century to produce a variety of well-defined polymers with a variety of chain architectures (Szwarc et al., “Polymerization Initiated by Electron Transfer to Monomer. A New Method of Formation of Block Polymers,” J. of the Am. Chem. Soc. 78(11):2656-2657 (1956)). For example, poly(styrene-b-butadiene-b-styrene) (SB S) has been used extensively as a modifier for asphalt (Xinjun Li et al., “Factors Study in Low-Temperature Fracture Resistance of Asphalt Concrete,” J. of Materials in Civil Engineering 22(2): 145-52 (2010); Gordon D. A., “Rheological Properties of Styrene Butadiene Styrene Polymer Modified Road Bitumens,” Fuel 82(14):1709-19 (2003)). Polybutadiene is commonly used to manufacture tire-treads and tire-carcasses (Hsieh et al., Anionic Polymerization: Principles and Practical Applications CRC Press (1996)). Anionic polymerization produces consistent, well defined polymers with dispersity (D) frequently less than 1.1. Anionic polymerization is capable of polymerizing vinyl aromatics, dienes, certain ring opening monomers, and other specialty monomers. It handles many of these monomers efficiently, with conversions exceeding 99% in fewer than four hours. Despite these advantages, anionic polymerization has its limitations. For instance, the carbanion active center will readily react with most electrophilic groups at rates competitive with monomer propagation. For this reason, the anionic polymerization of many vinyl and (meth)acrylic compounds will not yield high molecular weight polymers under commercially viable reaction conditions. For example, Fayt and Varshney have published successful polymerizations of acrylics (Fayt et al., “New Initiator System for the Living Anionic Polymerization of Tert-Alkyl Acrylates,” Macromolecules 20(6): 1442-44 (1987); Varshney et al., “Anionic Polymerization of (Meth)acrylic Monomers. 4. Effect of Lithium Salts as Ligands on The ‘living’ polymerization of Methyl Methacrylate Using Monofunctional Initiators,” Macromolecules 23(10):2618-22 (1990)) under cryogenic temperatures.

The dawn of reversible deactivation radical polymerization (RDRP, also commonly referred to as controlled radical polymerization) in the 1990s has opened some interesting doors for producing an array of new block copolymers. In general, these methods drastically limit the free radical concentration, driving the rate of termination reactions to nearly negligible levels. In spite of intense research in the area, RDRP methods have not yet been widely adopted in commercial practice. For example, atom transfer radical polymerization (ATRP) is one of the most commonly researched RDRP techniques. ATRP is capable of handling a wide variety of monomers: vinyl aromatic, (meth)acrylatic, and vinylic. A well designed ATRP will achieve good molecular weight control with dispersity values 1.1<D<1.5. One drawback with ATRP is sluggish reaction kinetics with vinyl aromatics and its inability to control diene polymerization. Another undesirable aspect is the requirement of a homogeneous transition metal catalyst, commonly copper, that presents challenges with respect to separations, toxicity and environmental stewardship. ATRP also is particularly sensitive to oxidants and other contaminants. Progress continues in addressing these issues, for example with adaptations such as the ARGET (Min et al., “Use of Ascorbic Acid as Reducing Agent for Synthesis of Well-Defined Polymers by ARGET ATRP,” Macromolecules 40(6): 1789-91 (2007)) (Activators ReGenerated by Electron Transfer) and ICAR (Min et al., “Use of Ascorbic Acid as Reducing Agent for Synthesis of Well-Defined Polymers by ARGET ATRP,” Macromolecules 40(6):1789-91(2007)) (Initiators for Continuous Activator Regeneration) implementations. Nonetheless, with these adaptations molecular weights greater than 100 kDa and D<1.5 are difficult targets requiring prohibitively long reaction times (Min et al., “Use of Ascorbic Acid as Reducing Agent for Synthesis of Well-Defined Polymers by ARGET ATRP,” Macromolecules 40(6): 1789-91 (2007)). Additionally, ARGET/ICAR place restrictions on solvent selection, often forcing the use of expensive and nonvolatile candidates such as dimethylformamide or anisole. Thus, the reduction of transition metal use comes at the price of extended long reaction times, additional separations challenges and costly solvents.

The Reversible Addition Chain Transfer (RAFT) polymerization method was published 3 years after ATRP (Moad et al., “Living Radical Polymerization by the RAFT Process—A Third Update,” Australian J. of Chem. 65(8):985-1076 (2012)). It has since proven to be a reliable polymerization technique for producing block copolymers of controlled molecular weight and low dispersity. Like ATRP, RAFT is capable of handling a wide variety of vinyl monomers. RAFT also suffers from sluggish kinetics with vinyl aromatic monomers, and while it can control diene polymerization, temperatures greater than 120° C. are required to achieve reasonable kinetics; under these conditions thermally tolerant chain transfer agents must be used and crosslinking is problematic (Wei et al., “Synthesis of Structured Nanoparticles of Styrene/Butadiene Block Copolymers via {RAFT} Seeded Emulsion Polymerization,” Polymer 51(17): 3879-86 (2010); Wei et al., “Ab Initio RAFT Emulsion Polymerization of Butadiene Using the Amphiphilic Poly(acrylic Acid-B-Styrene) Trithiocarbonate as Both Surfactant and Mediator,” J. of Polym. Sci. Part A: Polym. Chem. 49(13):2980-2989 (2011); Wei et al., “Styrene-Butadiene-Styrene Triblock Copolymer Latex via Reversible Addition-Fragmentation Chain Transfer Miniemulsion Polymerization,” Industrial & Engineering Chem. Research 51(47): 15530-35 (2012)). Unlike ATRP, RAFT does not require the use of transition metals, rather relying on a chain transfer agent (CTA) (See, for example, FIG. 3), that reversibly associates with chain ends to control the molecular weight. A CTA typically comprises thiocarbonyl compound such as a dithioester, trithiocarbonate, xanthate, or dithiocarbamate (Moad et al., “Living Radical Polymerization by the RAFT Process—A Third Update,” Australian J. of Chem. 65(8):985-1076(2012)); recently, a vinyl terminated polymer has been used as a sulfur-free chain transfer agent in a RAFT emulsion polymerization (Engelis et al., “Sequence-Controlled Methacrylic Multiblock Copolymers via Sulfur-Free RAFT Emulsion Polymerization,” Nat. Chem. 9(2):171-78 (2017)), evidently the first example of a sulfur-free RAFT polymerization.

RAFT chain transfer agents are reasonably tolerant to a variety of conditions; however, they are susceptible to thermal and certain chemical attacks. The temperature required to decompose the CTA is dependent on the Z group as well as the R group, with temperatures ranging from as low as 75° C. to as high as 272° C. (Legge et al., “Thermal Stability of Reversible Addition-Fragmentation Chain Transfer/Macromolecular Architecture Design by Interchange of Xanthates Chain-Transfer Agents,” J. of Polym. Sci. Part A: Polym. Chem. 44(24):6980-6987 (2006)). It is known that the CTA is much more thermally stable if the CTA is attached to a polymer-the same CTA as a small molecule versus attached to an acrylate polymer chain has a decomposition temperature of 75° C. and 272° C. respectively (Legge et al., “Thermal Stability of Reversible Addition-Fragmentation Chain Transfer/Macromolecular Architecture Design by Interchange of Xanthates Chain-Transfer Agents,” J. of Polym. Sci. Part A: Polym. Chem. 44(24):6980-6987 (2006)).

CTA's can also be chemically cleaved. CTA that is reacted with a large excess of AIBN-10 or more equivalents relative to CTA-will terminate the polymer with a tert-butyl cyano group (Willcock et al., “End Group Removal and Modification of RAFT Polymers,” Polym. Chem. 1(2):149-157 (2010)). Additionally the CTA can be reduced to a thiol end group by reaction with nucleophiles such as primary or secondary amines (Willcock et al., “End Group Removal and Modification of RAFT Polymers,” Polym. Chem. 1(2):149-157 (2010)).

RAFT, in contrast to ATRP and anionic polymerization, has the advantage of being more compatible with functional groups, less sensitive to impurities, and more tolerant of solvent choice. Additionally, good kinetics can be obtained with a wide variety of solvents including those typically used in anionic polymerization. This allows RAFT agents to be used in concert with living anionic polymers to produce macro-CTAs (Zhang et al., “Direct Transformation of Living Anionic Polymerization into RAFT-Based Polymerization,” Macromolecules 46(10):3985-3994 (2013)) using scalable and high yield methods.

By using methods and materials that are scalable, block copolymers that have been difficult or impossible to commercially produce are now accessible, opening the door to new applications as well as alternative monomer sources for existing applications. For example, if the price of a monomer such as butadiene were to rise, an alternative such as butyl acrylate could be used instead. Styrene-butadiene block co-polymers are used widely in various industries such as paving and construction (Durrieu et al., “The Influence of UV Aging of a Styrene/Butadiene/Styrene Modified Bitumen: Comparison between Laboratory and on Site Aging,” Fuel 86(10):1446-1451 (2007)), adhesives (Galan et al., “A Hot-Melt Pressure-Sensitive Adhesive Based on Styrene-Butadiene-Styrene Rubber. The Effect of Adhesive Composition on the Properties,” J. of Applied Polym. Sci. 62(8):1263-1275 (1996)), and paints and coatings (Jubete et al., “Water Uptake and Tensile Properties of Carboxylated Styrene Butadiene Rubber Based Water Born Paints: Models for Water Uptake Prediction,” Progress in Org. Coatings 59(2):126-133 (2007)). Materials like PS-PMMA block copolymers can make photoresistors (Stoykovich et al., “Directed Assembly of Block Copolymer Blends into Nonregular Device-Oriented Structures,” Science 308(5727):1442-1446 (2005)). BCP's of styrene, hydroxyethyl acrylate and butyl acrylate form a conductive material when mixed with polypyrrole capable of being solvated into many common solvents (Yin et al., “Electrical Conduction Near Percolation Threshold in Polymer Composite Containing Conducting Polypyrrole-Coated Insulating Polymer Fiber,” Japanese J of Applied Physics 35(9R): 4692 (1996)).

While there is one published method for producing a CTA directly from a polycarbanion (Zhang et al., “Direct Transformation of Living Anionic Polymerization Into RAFT-Based Polymerization,” Macromolecules 46(10): 3985-3994 (2013)), it requires cryogenic temperatures in order to produce the macro-CTA. Additionally, their Z group's are highly constrained, and xanthate, phenyl dithiocarbonate, trithiocarbanote, and dithiocarbamate are inaccessible Z groups through this method. Additionally, the use of hydroxyl capped anionically produced polymer with an acid halide terminated CTA can produce macro-CTA; however, yields were not reported and from applicant's experiments the yield is around 50% macro-CTA produced (Yin et al., “Glucose-Functionalized, Serum-Stable Polymeric Micelles From the Combination of Anionic and RAFT Polymerizations,” Macromolecules 45(10):4322-4332 (2012)).

The present invention is directed to overcoming these and other deficiencies in the art.

### SUMMARY OF THE INVENTION

One aspect of the present invention relates to a compound of Formula (I):

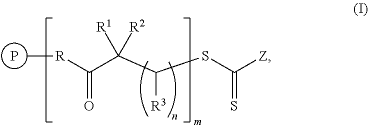

wherein

m is 0 or 1;

n is 0 or 30;

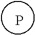

is a polymer;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2; and

Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl.

Another aspect of the present invention relates to a compound of Formula (II):

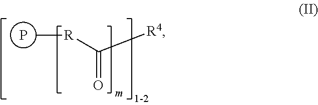

wherein

m is 0 or 1;

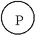

is a polymer;

R is —O—, —C₁₋₃₀ alkylene-O—, or carbon linkage;

R⁴ is absent or selected from the group consisting of

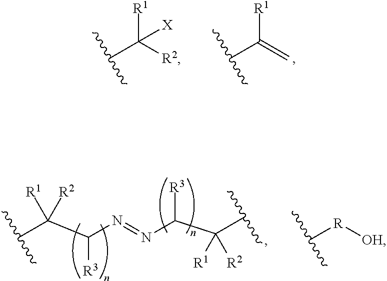

X is halogen;

n is 0 or 30;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2.

Another aspect of the present invention relates to a process for preparation of a compound of Formula (I):

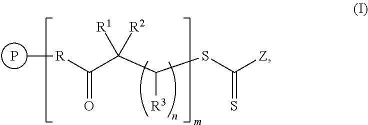

wherein

m is 0 or 1;

n is 0 to 30;

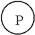

is a polymer;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2; and

Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl. This process includes providing a compound of Formula (II):

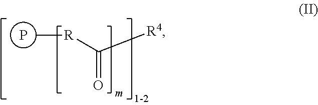

wherein

R⁴ is absent or selected from the group consisting of

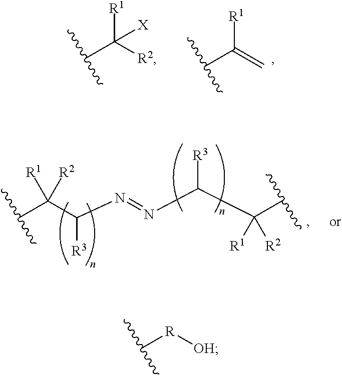

X is halogen,

and forming the compound of Formula (I) from compound of Formula (II).

Another aspect of the present invention relates to a process for preparation of a compound of Formula (IIa):

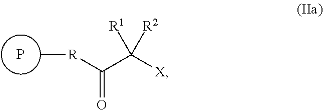

wherein

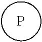

is a polymer;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2; and

X is halogen.

This process includes providing a compound of Formula (IId):

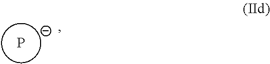

and forming the compound of Formula (IIa) from compound of Formula (IId).

Another aspect of the present invention relates to a process for preparation of a compound of Formula (IIb):

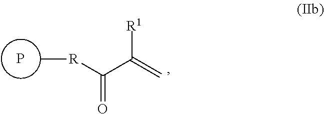

wherein

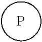

is a polymer;

R is —O—, —C₁₋₃₀ alkylene-O—, or carbon linkage;

R¹ is H or C₁₋₃₀ alkyl.

This process includes providing a compound of Formula (IId):

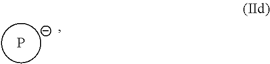

and forming the compound of Formula (IIb) from compound of Formula (IId).

A further aspect of the present invention relates to a process for preparation of a compound of Formula (IIc):

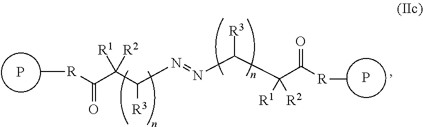

wherein

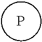

is a polymer;

n is 0 to 30;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2.

This process includes providing a compound of Formula (IId):

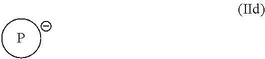

and forming the compound of Formula (IIc) from compound of Formula (IId).

Another aspect of the present invention relates to a process for the synthesis of a polymer. This process includes:

providing a monomer composition;

providing a compound of Formula (I):

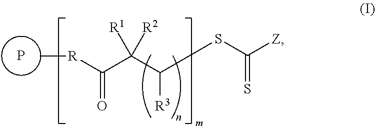

wherein

m is 0 or 1;

n is 0 or 30;

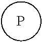

is a polymer;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2; and

Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl, and

polymerizing monomers within the monomer composition through controlled free radical polymerization with the compound of Formula (I) to form the polymer.

In the present application living anionic polystyrene was converted to a macro-CTA in a way that gives high yields with low scale-up costs. Direct reaction of thiocarbonyl with a living anion was avoided, allowing for the transformation to a macro-CTA. These macro-CTA's were specifically designed to keep the thiocarbonyl functionality at the end of each block (The R group is attached to the polymer chain instead of the Z group). This was done to protect the blocks of the polymer from cleaving as the CTA is sensitive to thermal and chemical attack. With the development of this macro-CTA it became possible to design block copolymers of styrenic and acrylate polymers with high efficiency.

### BRIEF DESCRIPTION OF THE DRAWINGS

FIG. 1 is a scheme, according to the present invention, showing synthetic routes for making macro chain transfer agents (“CTA”) for living styrene.

FIG. 2 is a scheme, according to the present invention, showing synthetic routes for replacement of ethylene oxide.

FIG. 3 shows CTA Compatibility Chart taken from Moad's RAFT Third Update (Moad et al., “Living Radical Polymerization by the RAFT Process—A Third Update,” Australian J. of Chem. 65(8): 985-1076 (2012), which is hereby incorporated by reference in its entirety).

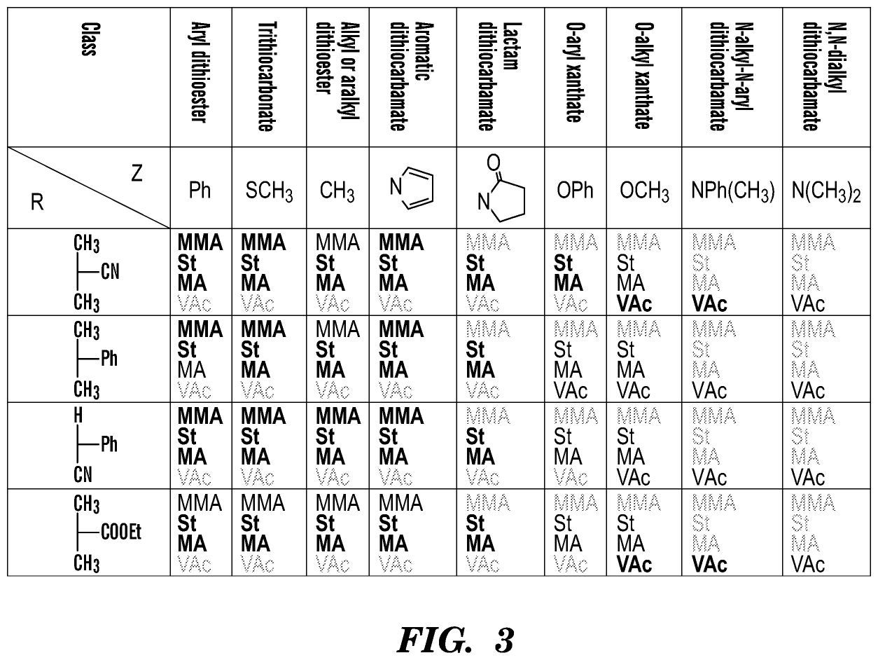

FIG. 4 shows the NMR of ethylene oxide capped polystyrene with the protons adjacent to the alkoxide.

FIG. 5 shows the NMR of polystyrene (“PS”) OH capped with alpha bromoisobutryl bromide having new protons adjacent to the ester.

FIG. 6 shows the NMR of PS-Macromonomer with the alkene region.

FIG. 7 shows the GPC trace of polystyrene-ethylene oxide (“PS-EO”) cap (solid line) vs PS aliquot (dotted line) where the aliquot has a slightly lower molecular weight than the PS-EO cap.

FIG. 8 shows the GPC trace of PS-EO-Tert-Bromine (Solid line) vs PS-EO (dotted line) where the tert-bromine has a slightly larger molecular weight than the EO capped PS.

FIG. 9 shows the GPC trace of polystyrene-poly(n-butyl acrylate) (“PS-NBA”) block copolymer, that was made from NBA (n-butyl acrylate) grown off PS (polystyrene). The solid line corresponds to residual polystyrene that has not been converted to macro-CTA (20%) and the dotted line is the amount of grown polystyrene-NBA (poly(n-butyl acrylate) (80%).

FIG. 10 shows PS-NBA from the ARGET method of ATRAF (atom transfer radical addition-fragmentation). The two left most peaks correspond to the grown polystyrene and account for 55% of the total amount of styrene.

FIG. 11 shows PS-NBA from a metal free method of ATRAF. The left most peak corresponds to the grown polystyrene and accounts for 28% of the total amount of styrene.

FIG. 12 shows PS-NBA from Macromonomer PS. The GPC trace shows unmodified styrene (dotted line) and PS macromonomer NBA (solid line)

FIG. 13 shows PS-NBA from an ester based macroinitator route. The peak on the left is the grown styrene which accounts for 64% of the total amount of styrene.

FIG. 14 shows PS-NBA from direct reaction with 1,1′-azobis(cyclohexanecarbonitrile) (“ACHN”). The peak on the left is the grown styrene which accounts for 11% of the total amount of styrene.

FIG. 15 shows PS-NBA of Weinreb amide synthesis. The peak on the left is the grown styrene which accounts for 32% of the total amount of styrene.

FIG. 16 shows PS-NBA from cyclic trithioate where there is a large amount of dead polymer (50%), some doubled polymer (20%), and some grown polymer (30%).

FIG. 17 shows NMR spectra of Weinreb amide tert bromine.

FIG. 18 shows deconvolved GPC of macromonomer method using methacryloyl chloride.

### DETAILED DESCRIPTION OF THE INVENTION

As used above, and throughout the description herein, the following terms, unless otherwise indicated, shall be understood to have the following meanings. If not defined otherwise herein, all technical and scientific terms used herein have the same meaning as is commonly understood by one of ordinary skill in the art to which this technology belongs. In the event that there is a plurality of definitions for a term herein, those in this section prevail unless stated otherwise.

The term “alkyl” means an aliphatic hydrocarbon group which may be straight or branched having about 1 to about 40 carbon atoms in the chain. Branched means that one or more lower alkyl groups such as methyl, ethyl, or propyl are attached to a linear alkyl chain. Exemplary alkyl groups include methyl, ethyl, n-propyl, i-propyl, n-butyl, t-butyl, n-pentyl, and 3-pentyl.

The term “alkenyl” means an aliphatic hydrocarbon group containing a carbon-carbon double bond and which may be straight or branched having about 2 to about 40 carbon atoms in the chain. Particular alkenyl groups have 2 to about 30 carbon atoms in the chain. Branched means that one or more lower alkyl groups such as methyl, ethyl, or propyl are attached to a linear alkenyl chain. Exemplary alkenyl groups include ethenyl, propenyl, n-butenyl, and i-butenyl.

The term “alkynyl” means an aliphatic hydrocarbon group containing a carbon-carbon triple bond and which may be straight or branched having about 2 to about 40 carbon atoms in the chain. Particular alkynyl groups have 2 to about 30 carbon atoms in the chain. Branched means that one or more lower alkyl groups such as methyl, ethyl, or propyl are attached to a linear alkynyl chain. Exemplary alkynyl groups include ethynyl, propynyl, n-butynyl, 2-butynyl, 3-methylbutynyl, and n-pentynyl.

The term “cycloalkyl” means a non-aromatic, saturated or unsaturated, mono- or multi-cyclic ring system of about 3 to about 5 carbon atoms, or of about 5 to about 7 carbon atoms, and which may include at least one double bond. Exemplary cycloalkyl groups include, without limitation, cyclopropyl, cyclobutyl, cyclopentyl, cyclohexyl, and cycloheptyl.

The term “cycloalkylalkyl” means a cycloalkyl-alkyl-group in which the cycloalkyl and alkyl are as defined herein. Exemplary cycloalkylalkyl groups include cyclopropylmethyl and cyclopentylmethyl. The alkyl radical and the cycloalkyl radical may be optionally substituted as defined herein.

As used herein, the term “alkane” refers to aliphatic hydrocarbons of formula CₙH₂ₙ₊₂, which may be straight or branched having about 1 to about 40 (e.g., 1-2, 1-3, 1-4, 1-5, 1-6, 1-7, 1-8) carbon atoms in the chain. Branched means that one or more lower alkyl groups such as methyl, ethyl, or propyl are attached to a linear alkyl chain. Exemplary alkanes include methane, ethane, n-propane, i-propane, n-butane, t-butane, n-pentane, and 3-pentane. The term “alkylene” refers to a divalent group formed from an alkane by removal of two hydrogen atoms. Exemplary alkylene groups include, but are not limited to, divalent groups derived from the alkanes described above.

As used herein, the term “cycloalkane” refers to aliphatic hydrocarbons of formula CₙH₂ₙ, which may be straight or branched having about 3 to about 8 carbon atoms in the chain. Exemplary cycloalkanes include cyclopropane, cyclobutane, cyclopentane, cyclohexane, and cycloheptane. The term “cycloalkylene” refers to a divalent group formed from a cycloalkane by removal of two hydrogen atoms. Exemplary cycloalkylene groups include, but are not limited to, divalent groups derived from the cycloalkanes described above.

As used herein, “heterocyclyl” or “heterocycle” refers to a stable 3- to 18-membered ring (radical) which consists of carbon atoms and from one to five heteroatoms selected from the group consisting of nitrogen, oxygen, and sulfur. For purposes of this application, the heterocycle may be a monocyclic, or a polycyclic ring system, which may include fused, bridged, or spiro ring systems; and the nitrogen, carbon, or sulfur atoms in the heterocycle may be optionally oxidized; the nitrogen atom may be optionally quaternized; and the ring may be partially or fully saturated. Examples of such heterocycles include, without limitation, azepinyl, azocanyl, pyranyl dioxanyl, dithianyl, 1,3-dioxolanyl, tetrahydrofuryl, dihydropyrrolidinyl, decahydroisoquinolyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, 2-oxoazepinyl, oxazolidinyl, oxiranyl, piperidinyl, piperazinyl, 4-piperidonyl, pyrrolidinyl, pyrazolidinyl, thiazolidinyl, tetrahydropyranyl, thiamorpholinyl, thiamorpholinyl sulfoxide, and thiamorpholinyl sulfone. Further heterocycles and heteroaryls are described in Katritzky et al., eds., Comprehensive Heterocyclic Chemistry: The Structure, Reactions, Synthesis and Use of Heterocyclic Compounds, Vol. 1-8, Pergamon Press, N.Y. (1984), which is hereby incorporated by reference in its entirety.

The term “monocyclic” used herein indicates a molecular structure having one ring.

The term “polycyclic” or “multi-cyclic” used herein indicates a molecular structure having two or more rings, including, but not limited to, fused, bridged, or spiro rings.

The term “aryl” means an aromatic monocyclic or multi-cyclic (polycyclic) ring system of 6 to about 19 carbon atoms, or of 6 to about 10 carbon atoms, and includes arylalkyl groups. The ring system of the aryl group may be optionally substituted. Representative aryl groups include, but are not limited to, groups such as phenyl, naphthyl, azulenyl, phenanthrenyl, anthracenyl, fluorenyl, pyrenyl, triphenylenyl, chrysenyl, and naphthacenyl.

The term “heteroaryl” means an aromatic monocyclic or multi-cyclic ring system of about 5 to about 19 ring atoms, or about 5 to about 10 ring atoms, in which one or more of the atoms in the ring system is/are element(s) other than carbon, for example, nitrogen, oxygen, or sulfur. In the case of multi-cyclic ring system, only one of the rings needs to be aromatic for the ring system to be defined as “heteroaryl”. Particular heteroaryls contain about 5 to 6 ring atoms. The prefix aza, oxa, thia, or thio before heteroaryl means that at least a nitrogen, oxygen, or sulfur atom, respectively, is present as a ring atom. A nitrogen, carbon, or sulfur atom in the heteroaryl ring may be optionally oxidized; the nitrogen may optionally be quaternized. Representative heteroaryls include pyridyl, 2-oxo-pyridinyl, pyrimidinyl, pyridazinyl, pyrazinyl, triazinyl, furanyl, pyrrolyl, thiophenyl, pyrazolyl, imidazolyl, oxazolyl, isoxazolyl, thiazolyl, isothiazolyl, triazolyl, oxadiazolyl, thiadiazolyl, tetrazolyl, indolyl, isoindolyl, benzofuranyl, benzothiophenyl, indolinyl, 2-oxoindolinyl, dihydrobenzofuranyl, dihydrobenzothiophenyl, indazolyl, benzimidazolyl, benzooxazolyl, benzothiazolyl, benzoisoxazolyl, benzoisothiazolyl, benzotriazolyl, benzo[1,3]dioxolyl, quinolinyl, isoquinolinyl, quinazolinyl, cinnolinyl, pthalazinyl, quinoxalinyl, 2,3-dihydro-benzo[1,4]dioxinyl, benzo[1,2,3]triazinyl, benzo[1,2,4]triazinyl, 4H-chromenyl, indolizinyl, quinolizinyl, 6aH-thieno[2,3-d]imidazolyl, 1H-pyrrolo[2,3-b]pyridinyl, imidazo[1,2-a]pyridinyl, pyrazolo[1,5-a]pyridinyl, [1,2,4]triazolo[4,3-a]pyridinyl, [1,2,4]triazolo[1,5-a]pyridinyl, thieno[2,3-b]furanyl, thieno[2,3-b]pyridinyl, thieno[3,2-b]pyridinyl, furo[2,3-b]pyridinyl, furo[3,2-b]pyridinyl, thieno[3,2-d]pyrimidinyl, furo[3,2-d]pyrimidinyl, thieno[2,3-b]pyrazinyl, imidazo[1,2-a]pyrazinyl, 5,6,7,8-tetrahydroimidazo[1,2-a]pyrazinyl, 6,7-dihydro-4H-pyrazolo[5,1-c][1,4]oxazinyl, 2-oxo-2,3-dihydrobenzo[d]oxazolyl, 3,3-dimethyl-2-oxoindolinyl, 2-oxo-2,3-dihydro-1H-pyrrolo[2,3-b]pyridinyl, benzo[c][1,2,5]oxadiazolyl, benzo[c][1,2,5]thiadiazolyl, 3,4-dihydro-2H-benzo[b][1,4]oxazinyl, 5,6,7,8-tetrahydro-[1,2,4]triazolo[4,3-a]pyrazinyl, [1,2,4]triazolo[4,3-a]pyrazinyl, 3-oxo-[1,2,4]triazolo[4,3-a]pyridin-2(3H)-yl, and the like.

The term “cyano” means a cyano group as shown below:

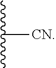 [SMILES: *C#N]

The term “halogen” means fluoro, chloro, bromo, or iodo.

The term “phenyl” means a phenyl group as shown below:

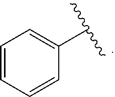 [SMILES: *c1ccccc1]

The term “benzyl” means a benzyl group as shown below

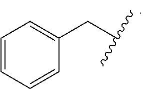 [SMILES: *Cc1ccccc1]

The term “substituted” or “optionally substituted” is used to indicate that a group may have a substituent at each substitutable atom of the group (including more than one substituent on a single atom), provided that the designated atom's normal valency is not exceeded and the identity of each substituent is independent of the others. In accordance with the present invention, up to three H atoms in each residue can be replaced with alkyl, halogen, haloalkyl, alkyenyl, haloalkenyl, cycloalkyl, cycloalkenyl, hydroxy, alkoxy, acyl, carboxy, carboalkoxy (also referred to as alkoxycarbonyl), carboxamido (also referred to as alkylaminocarbonyl), cyano, carbonyl, nitro, amino, alkylamino, dialkylamino, acylamino, amidino, mercapto, alkylthio, sulfoxide, sulfone, and/or sulfonic acid groups. “Unsubstituted” atoms bear all of the hydrogen atoms dictated by their valency. When a substituent is keto (i.e., ═O), then two hydrogens on the atom are replaced. Combinations of substituents and/or variables are permissible only if such combinations result in stable compounds. The terms “stable compound” or “stable structure” mean a compound that is sufficiently robust to survive isolation to a useful degree of purity from a reaction mixture, and formulation into an efficacious agent.

The term “phosphate” means a phosphate group as shown below:

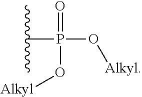

The term “carbon linkage” refers to a group -A-B-C-D-, -A-B-C-, -A-B-, or -A, wherein each A, B, C, and D are each independently selected from the group consisting of a single bond, a double bond, a triple bond, an optionally substituted C₂₋₃₀ alkylene, or an optionally substituted C₃₋₈ cycloalkylene

One aspect of the present invention relates to a compound of Formula (I):

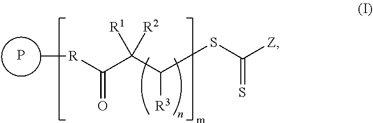

wherein

m is 0 or 1;

n is 0 or 30;

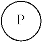

is a polymer;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2; and

Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl.

In one embodiment the compound of Formula (I) has the structure of Formula (Ia)-(Ie):

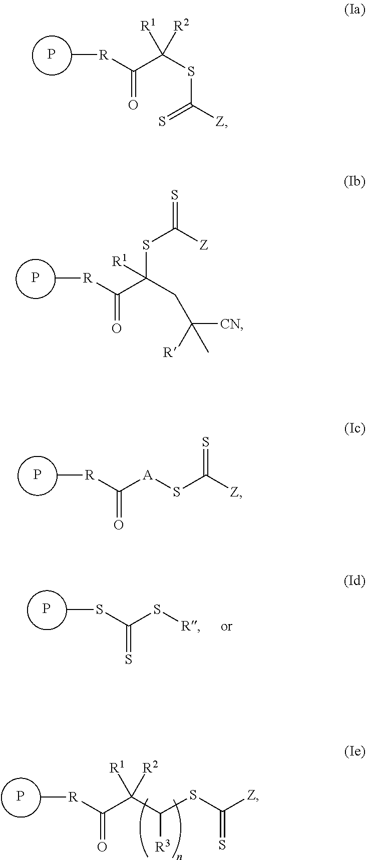

wherein

A is C₁₋₃₀ alkylene optionally substituted from 1 to 4 times with a substituent selected independently at each occurrence thereof from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b};

R′ is C₁₋₃₀ alkyl;

R″ is selected from the group consisting of C₁₋₃₀ alkyl, —OC₁₋₆ alkyl, —SC₁₋₆ alkyl, —O-aryl, —N(C₁₋₆ alkyl)₂, —N(aryl)(C₁₋₆ alkyl), aryl, heteroaryl, and heterocyclyl, wherein each of C₁₋₃₀ alkyl, aryl, heteroaryl, and heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl; and

p is 0, 1, or 2.

Polymer

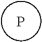

that can be used in accordance with the present invention is produced using anionic polymerization methods.

Polymer

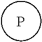

that can be used in accordance with the present invention can be any commercially available polymer or a polymer that is prepared by polymerization of any suitable monomer or a mixture thereof.

Suitable monomers that can be used in accordance with the present invention include vinyl (such as vinyl aromatic), acrylic (such as methacrylates, acrylates, methacrylamides, acrylamides, etc.), diolefin, nitrile, dinitrile, acrylonitrile monomer, a monomer with reactive functionality, and a crosslinking monomer, or a mixture thereof.

Vinyl aromatic monomers are exemplary vinyl monomers that can be used in accordance with the present invention, and include any vinyl aromatics optionally having one or more substituents on the aromatic moiety. The aromatic moiety can be either mono- or polycyclic. Exemplary vinyl aromatic monomers include styrene, α-methyl styrene, t-butyl styrene, vinyl xylene, vinyl naphthalene, vinyl pyridine, divinyl benzene, N-vinyl heteroaromatics (such as 4-vinylimidazole (Vim), N-vinylcarbazole (NVC), N-vinylpyrrolidone, etc.). Other exemplary vinyls include vinyl esters (such as vinyl acetate (VAc), vinyl butyrate (VB), vinyl benzoate (VBz)), N-vinyl amides and imides (such as N-vinylcaprolactam (NVCL), N-vinylpyrrolidone (NVP), N-vinylphthalimide (NVPI), etc.), vinylsulfonates (such as 1-butyl ethenesulfonate (BES), neopentyl ethenesulfonate (NES), etc.), vinylphosphonic acid (VPA), haloolefins (such as vinylidene fluoride (VF2)), etc. Exemplary methacrylates include C₁-C₆ (meth)acrylate (i.e., methyl methacrylate, ethyl methacrylate, propyl (meth)acrylate, butyl (meth)acrylate, isobutyl methacrylate, heptyl (meth)acrylate, or hexyl (meth)acrylate), 2-(acetoacetoxy)ethyl methacrylate (AAEMA), 2-aminoethyl methacrylate (hydrochloride) (AEMA), allyl methacrylate (AMA), cholesteryl methacrylate (CMA), t-butyldimethylsilyl methacrylate (BDSMA), (diethylene glycol monomethyl ether) methacrylate (DEGMA), 2-(dimethylamino)ethyl methacrylate (DMAEMA), (ethylene glycol monomethyl ether) methacrylate (EGMA), 2-hydroxyethyl methacrylate (HEMA), dodecyl methacrylate (LMA), methacryloyloxyethyl phosphorylcholine (MPC), (poly(ethylene glycol) monomethyl ether) methacrylate (PEGMA), pentafluorophenyl methacrylate (PFPMA), 2-(trimethylamonium)ethyl methacrylate (TMAEMA), 3-(trimethylamonium)propyl methacrylate (TMAPMA), triphenylmethyl methacrylate (TPMMA), etc. Other exemplary acrylates include 2-(acryloyloxy)ethyl phosphate (AEP), butyl acrylate (BA), 3-chloropropyl acrylate (CPA), dodecyl acrylate (DA), di(ethylene glycol) 2-ethylhexyl ether acrylate (DEHEA), 2-(dimethylamino)ethyl acrylate (DMAEA), ethyl acrylate (EA), ethyl a-acetoxyacrylate (EAA), ethoxyethyl acrylate (EEA), 2-ethylhexyl acrylate (EHA), isobornyl acrylate (iBoA), methyl acrylate (MA), propargyl acrylate (PA), (poly(ethylene glycol) monomethyl ether) acrylate (PEGA), tert-butyl acrylate (tBA), etc. Exemplary methacrylamides include N-(2-aminoethyl)methacrylamide (hydrochloride) (AEMAm) and N-(3-aminopropyl)methacrylamide (hydrochloride) (APMAm), N-(2-(dimethylamino)ethyl)acrylamide (DEAPMAm), N-(3-(dimethylamino)propyl)methacrylamide (hydrochloride) (DMAPMAm), etc. Other exemplary acrylamides include acrylamide (Am) 2-acrylamido-2-methylpropanesulfonic acid sodium salt (AMPS), N-benzylacrylamide (BzAm), N-cyclohexylacrylamide (CHAm), diacetone acrylamide (N-(1,1-dimethyl-3-oxobutyl) acrylamide) (DAAm), N,N-diethylacrylamide (DEAm), N,N-dimethylacrylamide (DMAm), N-(2-(dimethylamino)ethyl)acrylamide (DMAEAm), N-isopropylacrylamide (NIPAm), N-octylacrylamide (OAm), etc. Exemplary nitriles include acrylonitrile, adiponitrile, methacrylonitrile, etc. Exemplary diolefins include butadiene, isoprene, etc.

The radically polymerizable monomers suitable for usage herein also include those monomers with reactive functionality, e.g., a ‘clickable’ functionality so that when the monomers are incorporated in blocks, these ‘clickable’ functional groups can be used as a precursor to a polymer brush or copolymerized to provide sites for the attachment of functionality or for crosslinking. Exemplary reactive functionality include functional groups suitable for azide-alkyne 1,3-dipolar cycloaddition, such as azide functionality; “active ester’ functional groups that are particular active with primary amine functionality; functional groups with protected thiol, hydrazide or amino functionality; functional groups with isocyanate or isothiocyanate functionality, etc.

The radically polymerizable monomers suitable for usage herein can also include those crosslinking monomers. The monomers can include degradable crosslinks such as an acetal linkage, or disulfide linkages, resulting in the formation of degradable crosslinks. Exemplary crosslinking monomers diethyleneglycol dimethacrylate (DEGDMA), triethylene glycol dimethacrylate (TEGDMA), ethyleneglycol dimethacrylate (EGDMA), hexane-1,6-diol diacrylate (HDDA), methylene-bis-acrylamide (MBAm), divinylbenzene (DVB), etc.

A more extensive list of exemplary methacrylate monomers, acrylate monomers, methacrylamide monomers, acrylamide monomers, styrenic monomers, diene monomers, vinyl monomers, monomers with reactive functionality, and crosslinking monomers that are suitable for usage as the radically polymerizable monomers herein has been described in Moad et al., “Living Radical Polymerization by the Raft Process—a Third Update,” Australian Journal of Chemistry 65: 985-1076 (2012), which is hereby incorporated by reference in its entirety.

The polymer

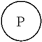

can also be prepared by polymerization of one or more monomeric triglycerides, typically derived from a plant oil, animal fat, or a synthetic triglyceride. This polymerized plant oil or animal oil can be subsequently partially or fully saturated via a catalytic hydrogenation post-polymerization. The monomeric oils used can be any triglycerides or triglyceride mixtures that are radically polymerizable. These triglycerides or triglyceride mixtures are typically plant oils. Suitable plant oils include, but are not limited to, a variety of vegetable oils such as soybean oil, peanut oil, walnut oil, palm oil, palm kernel oil, sesame oil, sunflower oil, safflower oil, rapeseed oil, linseed oil, flax seed oil, colza oil, coconut oil, corn oil, cottonseed oil, olive oil, castor oil, false flax oil, hemp oil, mustard oil, radish oil, ramtil oil, rice bran oil, salicornia oil, tigernut oil, tung oil, etc., and mixtures thereof. Typical vegetable oil used herein includes soybean oil, linseed oil, corn oil, flax seed oil, or rapeseed oil.

In one embodiment,

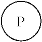

is polystyrene, polybutadiene, or polyisoprene.

In another embodiment,

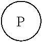

is a polymer prepared by polymerization of styrene, butadiene, isoprene, hexamethyl(cyclotrisiloxane), butylene oxide, propylene oxide, ethylene oxide, or a mixture thereof.

Another aspect of the present invention relates to a compound of Formula (II):

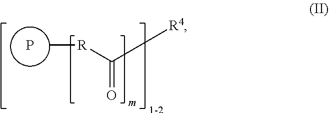

wherein

m is 0 or 1;

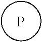

is a polymer;

R is —O—, —C₁₋₃₀ alkylene-O—, or carbon linkage;

R⁴ is absent or selected from the group consisting of

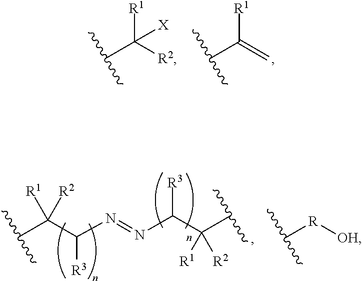

X is halogen;

n is 0 or 30;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2.

In one embodiment the compound of Formula (II) has the structure of Formula (IIa)-(IIe):

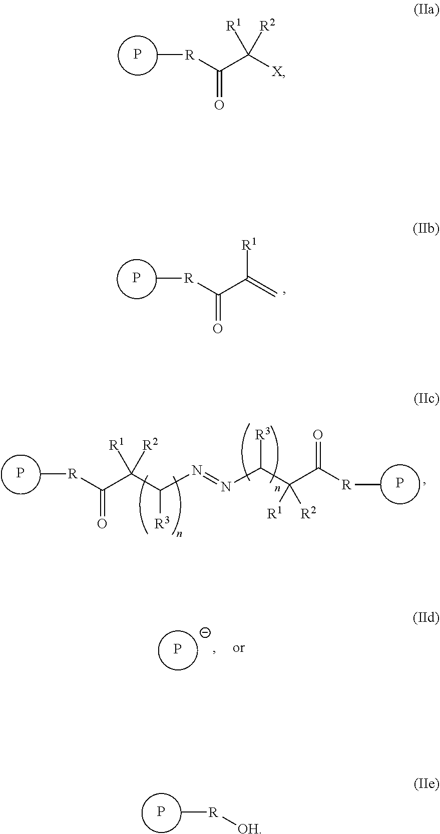

Another aspect of the present invention relates to a process for preparation of a compound of Formula (I):

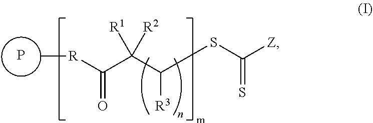

wherein

m is 0 or 1;

n is 0 to 30;

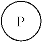

is a polymer;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN; R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2; and

Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl. This process includes providing a compound of Formula (II):

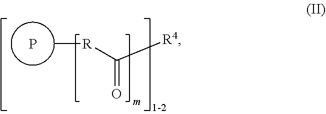

wherein

R⁴ is absent or selected from the group consisting of

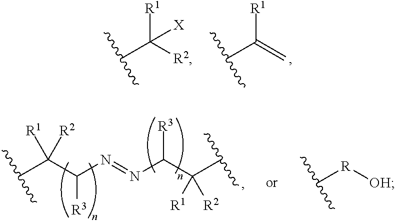

X is halogen,

and forming the compound of Formula (I) from compound of Formula (II).

The reaction can be carried out in a variety of solvents including toluene, THF, cyclohexane, cyclopentane, dioxane, THP, anisole, ethers, and benzene.

Reaction temperatures can range from room temperature to up to 200° C. Typical reaction temperatures are 150° C. or lower, for instance, from 0 to 150° C., from 10 to 150° C., from 10 to 80° C. In one embodiment, the reaction is carried out at a temperature of from 10 to 80° C. In another embodiment, the reaction is carried out at a temperature of 80° C. In yet another embodiment, the reaction is carried out at a room temperature.

Reaction times can range from 5 minutes to 24 hours, for instance, from 10 minutes to 20 hours, from 20 minutes to 12 hours, from 1 to 8 hours. In one embodiment, the reaction is carried out for 8 hours. In another embodiment, the reaction is carried out overnight.

The reaction can further include reducing agents, copper containing compounds, radical initiators, coupling agents, and amines.

Suitable reducing agents include any “weak” reducing agent. For example, tin(II) ethyl hexanoate, ascorbic acid, citric acid, and any other organotin complexes.

Suitable copper containing compounds include copper (II) chloride, copper (I) chloride, copper (II) bromide, copper (I) bromide, copper (II) iodide, copper (II) iodide, and copper wire.

Suitable amines include N,N,N′,N″,N″-pentamethyldiethylenetriamine (PMDTA), 2,2′-bipyridine (bpy), 4,4′-di-5-nonyl-2,2′-bipyridine (dNbpy), 4,4′,4″-tris(5-nonyl)-2,2′:6′,2″-terpyridine (tNtpy), N,N,N′,N′,N″-pentamethyldiethylenetriamine (PMDETA), 1,1,4,7,10,10-hexamethyltriethylenetetramine (HMTETA), tris(2-dimethylaminoethyl)aminea (Me6TREN), N,N-bis(2-pyridylmethyl)octadecylamine (BPMODA), N,N,N′,N′-tetra[(2-pyridal)methyl]ethylenediamine (TPEDA), tris[(2-pyridyl)methyl]aminea (TPMA), tris(2-aminoethyl)amine (TREN), tris(2-bis(3-butoxy-3-oxopropyl)aminoethyl)amine (BA6TREN), and tris(2-bis(3-(2-ethylhexoxy)-3-oxopropyl)aminoethyl) (EHA6TREN).

Suitable coupling agents include, but are not limited to, DMAP, EDC, and DIC.

Suitable radical initiators include benzoyl peroxide, azobisisobutyronitrile (AIBN), 1,1′ azobis(cyclohexanecarbonitrile) (ABCN), bis(tert-butylperoxy)butane, 1,1-bis(tert-butylperoxy)cyclohexane, 1,1-bis(tert-butylperoxy)-3,3,5-trimethylcyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 1 2,4-pentanedione peroxide, peracetic acid, potassium persulfate, or 4,4′-Azobis(4-cyanovaleric acid) (ACVA).

In some embodiments, the reaction is carried out under inert atmosphere. In some embodiments, reaction can be carried out under 254 nm wavelength light.

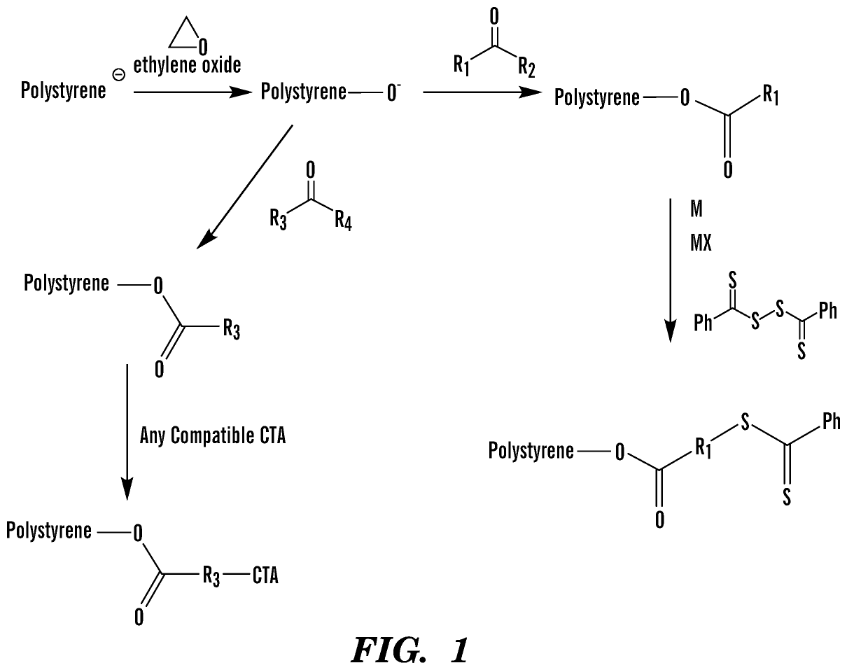

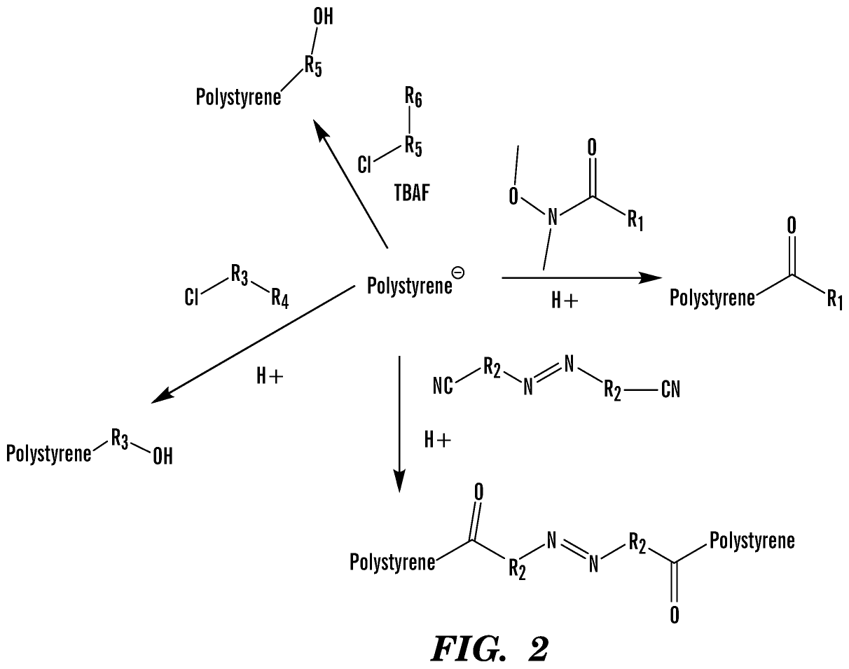

According to the present invention, compounds of Formula (I) can be prepared as shown in FIGS. 1 and 2.

In one embodiment compound of Formula (I) is prepared by reacting the compound of Formula (II) with a compound of Formula (III):

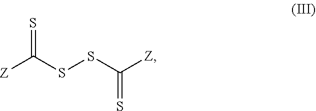

under conditions effective to produce the compound of Formula (I).

In at least one embodiment, the compound of Formula (II) has the Formula (IIa):

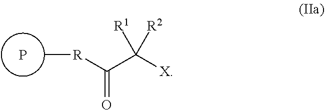

In at least one embodiment, compound of Formula (IIa) is prepared by a process comprising:

providing compound of Formula (IIe):

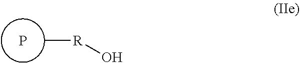

and forming the compound of Formula (IIa) from compound of Formula (IIe).

The reaction can be carried out in a variety of solvents including toluene, THF, cyclohexane, cyclopentane, dioxane, THP, anisole, ethers, and benzene.

Reaction temperatures can range from room temperature to up to 200° C. Typical reaction temperatures are 150° C. or lower, for instance, from 0 to 150° C., from 10 to 150° C., from 10 to 80° C. In one embodiment, the reaction is carried out at a temperature of from 10 to 80° C. In another embodiment, the reaction is carried out at 80° C. In yet another embodiment, the reaction is carried out at 40° C.

Reaction times can range from 1 to 24 hours, for instance, from 1 to 20 hours, from 1 to 12 hours, from 1 to 8 hours. In one embodiment, the reaction is carried out for 12 hours. In another embodiment, the reaction is carried out overnight.

The reaction can further include base and/or coupling agents,

Suitable bases can include any suitable tertiary amines, for example, triethylamine, diisopropyl ethylamine, collidine, quinuclidine, or 1,8-diazabicyclo[5.4.0]undec-7-ene (DBU).

Suitable coupling agents include, but are not limited to, DMAP, EDC, and DIC.

In some embodiments, the reaction is carried out under inert atmosphere.

In at least one embodiment, compound of Formula (IIa) is prepared by reacting the compound of Formula (IIe) with a compound of Formula (IV):

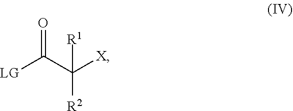

wherein LG is a suitable leaving group;

under conditions effective to produce the compound of Formula (IIa).

In at least one embodiment, the suitable leaving group is selected from the group consisting of OH, halogen, and R²

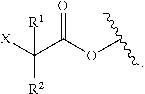

The compound of Formula (IIe) is prepared by a process comprising providing a compound of Formula (IId):

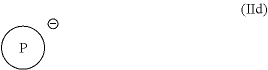

and forming the compound of Formula (IIe) from the compound of Formula (IId).

In at least one embodiment, the compound of Formula (IIe) is prepared by a process comprising reacting the compound of Formula (IId) with an alcohol or an epoxide under conditions effective to produce the compound of Formula (IIe). Both unprotected and protected alcohol can be used in this process.

The reaction can be carried out in a variety of solvents including toluene, THF, cyclohexane, cyclopentane, dioxane, THP, anisole, ethers, and benzene.

In some embodiments, the reaction is carried out under inert atmosphere.

In at least one embodiment, the compound of Formula (IIa) is prepared by a process comprising providing a compound of Formula (IId):

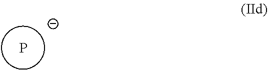

and forming the compound of Formula (IIa) from the compound of Formula (IId).

In at least one embodiment, the compound of Formula (IIa) is prepared by a process comprising reacting the compound of Formula (IId) with a compound of Formula (IVa):

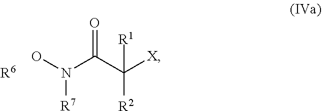

wherein R⁶ and R⁷ are each independently H or C₁₋₆ alkyl,

under conditions effective to produce the compound of Formula (II).

In another embodiment compound of Formula (I) is prepared by reacting the compound of Formula (II) with a compound of Formula (V):

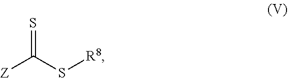

wherein R⁸ is C₁₋₃₀ alkyl optionally substituted from 1 to 4 times with a substituent selected independently at each occurrence thereof from the group consisting of C₁₋₃₀ alkyl, —CN, aryl, and —COOC₁₋₆ alkyl, under conditions effective to produce the compound of Formula (I).

In at least one embodiment, the compound of Formula (II) is compound of Formula (IIb):

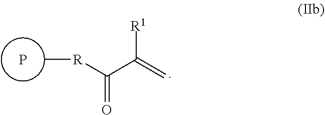

In at least one embodiment, the compound of Formula (IIb) is prepared by a process comprising providing compound of Formula (IIe):

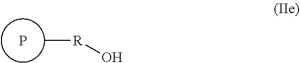

and forming the compound of Formula (IIb) from compound of Formula (IIe).

The reaction can be carried out in a variety of solvents including toluene, THF, cyclohexane, cyclopentane, dioxane, THP, anisole, ethers, and benzene.

Reaction temperatures can range from room temperature to up to 150° C. Typical reaction temperatures are 100° C. or lower, for instance, from 0 to 100° C., from 10 to 100° C., from 10 to 80° C. In one embodiment, the reaction is carried out at 55° C. In another embodiment, the reaction is carried out at 40° C.

Reaction times can range from 1 to 24 hours, for instance, from 1 to 20 hours, from 1 to 12 hours. In one embodiment, the reaction is carried out for 12 hours. In another embodiment, the reaction is carried out for 20 hours.

The reaction can further include a suitable base such as triethylamine, diisopropyl ethylamine, collidine, quinuclidine, or 1,8-diazabicyclo[5.4.0]undec-7-ene (DBU).

In some embodiments, the reaction is carried out under inert atmosphere.

In at least one embodiment, the compound of Formula (IIb) is prepared by a process comprising reacting the compound of Formula (IIe) with a compound of Formula (VI):

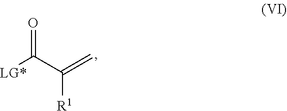

wherein LG* is a suitable leaving group, under conditions effective to produce the compound of Formula (IIb).

In at least one embodiment, the suitable leaving group is selected from the group consisting of OH, halogen, and

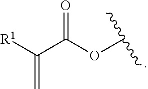

In at least one embodiment, the compound of Formula (IIe) is prepared by a process comprising providing a compound of Formula (IId):

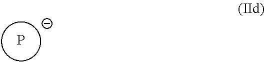

and forming the compound of Formula (IIe) from the compound of Formula (IId).

In at least one embodiment, the compound of Formula (IIb) is prepared by a process comprising providing a compound of Formula (IId):

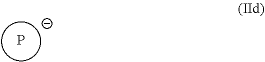

and forming the compound of Formula (IIb) from the compound of Formula (IId).

In at least one embodiment, the compound of Formula (IIb) is prepared by a process comprising reacting the compound of Formula (IId) with a compound of Formula (VIa):

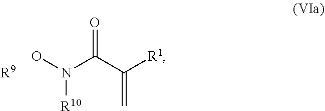

wherein R⁹ and R¹⁰ are each independently H or C₁₋₆ alkyl,

under conditions effective to produce the compound of Formula (IIb).

In at least one embodiment, the compound of Formula (II) has the Formula (IIc):

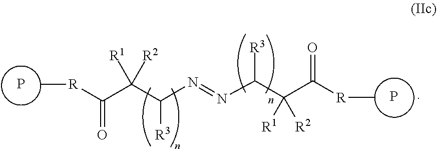

In at least one embodiment, the compound of Formula (IIc) is prepared by a process comprising providing a compound of Formula (IIe):

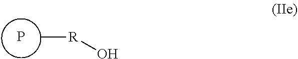

and reacting the compound of Formula (IIe) with a compound of Formula (VII):

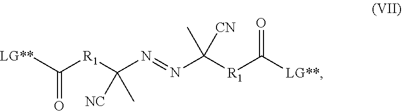

wherein LG** is a suitable leaving group, under conditions effective to produce the compound of Formula (IIc).

The reaction can be carried out in a variety of solvents including toluene, THF, cyclohexane, cyclopentane, dioxane, THP, anisole, ethers, and benzene.

Reaction temperatures can range from 0 to 100° C. Typical reaction temperatures are 100° C. or lower, for instance, from 0 to 50° C., from 10 to 40° C. In one embodiment, the reaction is carried out at room temperature.

Reaction times can range from 1 to 24 hours, for instance, from 1 to 20 hours, from 1 to 12 hours, from 1 to 8 hours. In one embodiment, the reaction is carried out for 20 hours. In another embodiment, the reaction is carried out overnight.

The reaction can further include base and/or coupling agents.

Suitable bases can include any suitable tertiary amines, for example, triethylamine, diisopropyl ethylamine, collidine, quinuclidine, or 1,8-diazabicyclo[5.4.0]undec-7-ene (DBU).

Suitable coupling agents include, but are not limited to, DMAP, EDC, and DIC.

In some embodiments, the reaction is carried out under inert atmosphere.

In at least one embodiment, the suitable leaving group is selected from the group consisting of OH, halogen, and

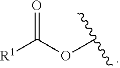

In at least one embodiment, the compound of Formula (IIe) is prepared by a process comprising providing a compound of Formula (IId): (IId)

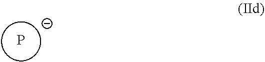

and forming the compound of Formula (IIe) from the compound of Formula (IId).

In at least one embodiment, the compound of Formula (IIc) is prepared by a process comprising providing a compound of Formula (IId):

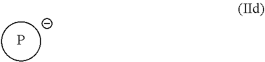

and reacting the compound of Formula (IId) with a compound of Formula (VIIa):

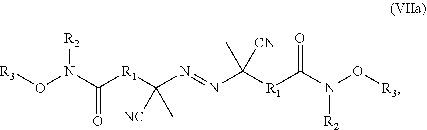

under conditions effective to produce the compound of Formula (IIc).

In at least one embodiment, the compound of Formula (IIc) is prepared by a process comprising providing a compound of Formula (IId):

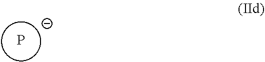

and reacting the compound of Formula (IIe) with a compound of Formula (VIII):

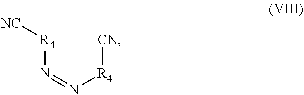

wherein R₄ is C₁₋₆ alkylene or C₃₋₈ cycloalkylene, wherein C₁₋₆ alkylene or C₃₋₈ cycloalkylene can be optionally substituted from 1 to 4 times with C₁₋₃₀ alkyl;
under conditions effective to produce the compound of Formula (IIc).

In yet another embodiment, the compound of Formula (I) is prepared by process comprising reacting the first intermediate compound of Formula (IId) with a compound of Formula:

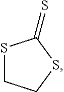

under conditions effective to produce the compound of Formula (I).

In another embodiment, the compound of Formula (I) is prepared by process comprising reacting the first intermediate compound of Formula (IIe) with a compound of Formula (VI):

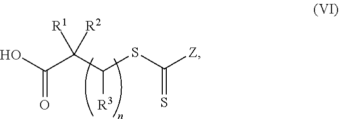

under conditions effective to produce the compound of Formula (I).

Another aspect of the present invention relates to a process for preparation of a compound of Formula (IIa):

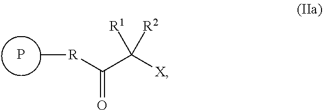

wherein

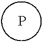

is a polymer;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2; and

X is halogen.

This process includes providing a compound of Formula (IId):

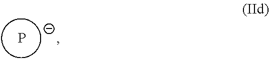

and forming the compound of Formula (IIa) from compound of Formula (IId).

In one embodiment, the compound of Formula (IIa) is prepared by the process comprising reacting the compound of Formula (IId) with a compound of Formula (IVa):

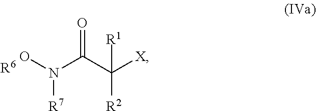

wherein R⁶ and R⁷ are each independently H or C₁₋₆ alkyl, under conditions effective to produce the compound of Formula (IIa).

Another aspect of the present invention relates to a process for preparation of a compound of Formula (IIb):

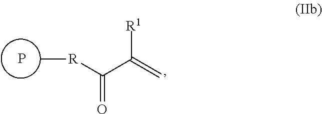

wherein

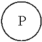

is a polymer;

R is —O—, —C₁₋₃₀ alkylene-O—, or carbon linkage;

R¹ is H or C₁₋₃₀ alkyl.
This process includes providing a compound of Formula (IId):

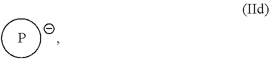

and forming the compound of Formula (IIb) from compound of Formula (IId).

In one embodiment, the compound of Formula (IIb) is prepared by the process comprising reacting the compound of Formula (IId) with a compound of Formula (VIa):

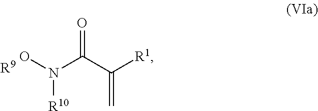

wherein R⁹ and R¹⁰ are each independently H or C₁₋₆ alkyl,

under conditions effective to produce the compound of Formula (IIb).

A further aspect of the present invention relates to a process for preparation of a compound of Formula (IIc):

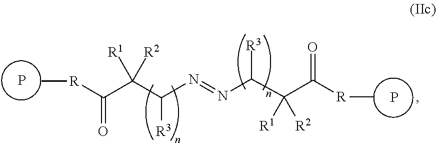

wherein

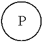

is a polymer;

n is 0 to 30;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2.

This process includes providing a compound of Formula (IId):

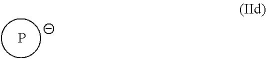

and forming the compound of Formula (IIc) from compound of Formula (IId).

In one embodiment, the compound of Formula (IIc) is prepared by the process comprising reacting the compound of Formula (IId) with a compound of Formula (VIIa):

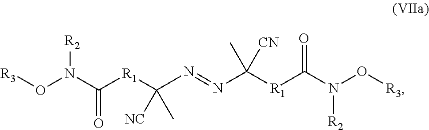

under conditions effective to produce the compound of Formula (IIc).

Another aspect of the present invention relates to a process for the synthesis of a polymer. This process includes:

providing a monomer composition;

providing a compound of Formula (I):

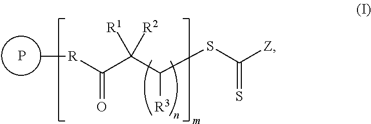

wherein

m is 0 or 1;

n is 0 or 30;

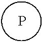

is a polymer;

R is —O—, —C₁₋₃₀ alkylene-O—, or carbon linkage;

R¹ is H or C₁₋₃₀ alkyl;

R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;

R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;

R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;

p is 0, 1, or 2; and

Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl, and

polymerizing monomers within the monomer composition through controlled free radical polymerization with the compound of Formula (I) to form the polymer.

The polymerizing step is performed through controlled free radical polymerization which involves living/controlled polymerization with free radical as the active polymer chain end (Moad et al., The Chemistry of Radical Polymerization—Second Fully Revised Edition, Elsevier Science Ltd. (2006), which is hereby incorporated by reference in its entirety). This type of polymerization is a form of addition polymerization where the ability of a growing polymer chain to terminate has been removed. The rate of chain initiation is thus much larger than the rate of chain propagation. The result is that the polymer chains grow at a more constant rate than seen in traditional chain polymerization and their lengths remain very similar. The polymerizing step typically occurs in the presence of a free radical initiator, and a catalyst or a chain transfer agent to form the polymer.

One form of controlled free radical polymerization is Radical Addition-Fragmentation Chain Transfer (RAFT). Radical Addition-Fragmentation Chain Transfer (RAFT) polymerization is a type of living polymerization or controlled polymerization, utilizing a chain transfer agent (CTA). Conventional RAFT polymerization mechanism, consisting of a sequence of addition-fragmentation equilibria, is shown in Moad et al., “Living Radical Polymerization by the Raft Process—a First Update,” Australian Journal of Chemistry 59: 669-92 (2006), which is incorporated herein by reference in its entirety. The RAFT polymerization reaction starts with initiation. Initiation is accomplished by adding an agent capable of decomposing to form free radicals; the decomposed free radical fragment of the initiator attacks a monomer yielding a propagating radical (P′ₙ), in which additional monomers are added producing a growing polymer chain. In the propagation step, the propagating radical (P′ₙ) adds to a chain transfer agent (CTA), followed by the fragmentation of the intermediate radical forming a dormant polymer chain and a new radical (R′). This radical (R′) reacts with a new monomer molecule forming a new propagating radical (P′ₘ). In the chain propagation step, (P′ₙ) and (P′ₘ) reach equilibrium and the dormant polymer chain provides an equal probability to all polymers chains to grow at the same rate, allowing polymers to be synthesized with narrow polydispersity. Termination is limited in RAFT, and, if it occurs, it is negligible. Targeting a specific molecular weight in RAFT can be calculated by multiplying the ratio of monomer consumed to the concentration of CTA used by the molecular weight of the monomer.

The initiating agents often are referred to as “initiators.” Suitable initiators depend greatly on the details of the polymerization, including the types of monomers being used, the type of catalyst system, the solvent system, and the reaction conditions. A typical radical initiator can be azo compounds, which provide a two-carbon centered radical. Radical initiators such as benzoyl peroxide, azobisisobutyronitrile (AIBN), 1,1′ azobis(cyclohexanecarbonitrile) (ABCN), bis(tert-butylperoxy)butane, 1,1-bis(tert-butylperoxy)cyclohexane, 1,1-bis(tert-butylperoxy)-3,3,5-trimethylcyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 1 2,4-pentanedione peroxide, peracetic acid, potassium persulfate, or 4,4′-Azobis(4-cyanovaleric acid) (ACVA); redox initiator such as benzoyl peroxide/N,N-dimethylaniline; microwave heating initiator; photoinitiator such as (2,4,6-trimethylbenzoyl)-diphenylphosphine oxide; gamma radiation initiator; or Lewis acids such as scandium(III) triflate or yttrium (III) triflate, are typically used in RAFT polymerization.

More details for selection of initiators and reaction conditions for RAFT reaction as well as detailed descriptions for RAFT polymerization can be found in U.S. Patent Application Publication No. 2014/0343192 A1 to Cochran et al., which is hereby incorporated by reference in its entirety.

In one embodiment, the polymerizing is carried out by reversible addition-fragmentation chain-transfer polymerization (RAFT), in the presence of a free radical initiator and a solvent.

In RAFT polymerization, reaction time, temperature, and solvent concentration should be chosen appropriately to ensure the production of non-crosslinked elastomers. Reaction time relates closely to the temperature the reaction is carried out at: higher temperature requires shorter reaction times and lower temperature requires longer reaction times.

Temperatures for the RAFT polymerization can range from room temperature to up to 300° C. The optimal temperature is the minimum at which polymerization can occur over reasonable time scales, e.g., 6-48 hours. Typical reaction temperatures for a RAFT reaction is 250° C. or lower, for instance, from 0 to 250° C., from 50 to 220° C., from 80 to 200° C., from 40 to 100° C., from 50 to 85° C., or from 0 to 50° C. In one embodiment, the polymerizing is carried out at a temperature of 0 to 160° C.

The monomer to CTA ratio can vary depending upon the desired molecular weight. In one embodiment, RAFT polymerization is carried out at a molar ratio of the chain transfer agent to the monomer ranging from 1:1 to 1:10000.

The solvent is selected based the requirements of monomer solubility and a normal boiling point compatible with the polymerization temperature. The solvent used in the RAFT polymerization may be toluene, dioxane, THF, chloroform, cyclohexane, dimethyl sulfoxide, dimethyl formamide, acetone, acetonitrile, n-butanol, n-pentnaol, chlorobenzene, dichloromethane, diethylether, tert-butanol, 1,2,-dichloroethylene, diisopropylether, ethanol, ethylacetate, ethylmethylketone, heptane, hexane, isopropylalcohol, isoamylalcohol, methanol, pentane, n-propylacohol, pentachloroethane, 1,1,2,2,-tetrachloroethane, 1,1,1,-trichloroethane, tetrachloroethylene, tetrachloromethane, trichloroethylene, water, xylene, benzene, nitromethane, glycerol, or a mixture thereof. In one embodiment, solvent is the methanol, glycerol, or a mixture thereof.

The solvent can further include stabilizers, surfactants, or dispersants.

The monomer composition can comprise of one or more types of monomers.

Any suitable monomer described above can be used in accordance with the present invention.

In one embodiment, the one or more types of monomers is selected from the group consisting of vinyl aromatic monomers and acrylate monomers.

In at least one embodiment, the one or more types of monomers is selected from the group consisting of styrene, butyl acrylate, methyl acrylate, and methyl methacrylate.

The concentrations of the monomer used in the reactions depend partially on the solubility of the monomer and the polymer products as well as the evaporation temperature of the solvent. Solvent concentration can affect the gelation of the polymer. Insufficient solvent in the RAFT reaction can cause the polymer to crosslink in a shorter time period without ever reaching high enough conversions. Therefore, the solvent is typically added in excess to allow the polymer chains to grow and obtain a conversion rate to 80% without risk of the polymer reaching the gel point. The concentration of the monomer dissolved in the solvent in the RAFT reactions may range from 1% to 100% weight percentage monomer. Typically, a monomer concentration of less than 90 wt % is suitable to ensure the solubility of the resulting polymers and additionally to prevent premature gelation.

In one embodiment, the method is carried out in the presence of a solvent, with the monomer having a concentration, when dissolved in the solvent, ranging from 1 wt % to 90 wt %, for instance, from 1 wt % to 40 wt %, from 1 wt % to 10 wt %, or from 20 wt % to 30 wt %.

In one embodiment, RAFT polymerization of the monomer is carried out with a free radical initiator selected from the group consisting of benzoyl peroxide and azobisisobutyronitrile.

The polymer produced by the process described in the present invention can be a homopolymer, copolymer, or block copolymer having a linear or branched-chain structure.

In another embodiment, the polydispersity index (DPI) of the polymer is less than 2. Alternatively, the polydispersity index (DPI) of the polymer is less than 1.5. As a further alternative, the polydispersity index (DPI) of the polymer is less than 1.2.

### EXAMPLES

### Example 1—Production of Macro-CTA Using ATR Method

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passaging through an activated alumina column. HPLC grade cyclohexane (CHX) was purchased from Fisher Scientific and purified by inerting with argon and then passing through an oxygen scavenging column (Engelhard q5) and an activated alumina column.

CHX (500 mL) was added to an argon-filled round bottom flask equipped with a stir bar. The flask was then heated to 40° C. in a water bath. Sec-butyllithium solution (4.5 mL) (targeting an 8 kDa polymer) was added. Styrene (50 g) was introduced slowly over the course of 30 minutes to limit the temperature increase due to the exothermic nature of the polymerization. Finally, an aliquot was taken in order to determine the molecular weight of the polymer prior to further modification. The aliquot was processed by the GPC and showed a molecular weight of 10 kDa.

Ethylene Oxide Capping

Next, while the styrene was still living, ethylene oxide was used to provide a primary alcohol at the end of the styrene chain. This was done according to established procedures (Epps T. H., “Locating Network Phases in Linear ABC Triblock Copolymers,” University of Minnesota, Thesis (2004), which is hereby incorporated by reference in its entirety). Ethylene oxide (EO) was purchased from Sigma Aldrich and triple purified: The ethylene oxide (minimum of 10 molar excess with respect to sec-butyllithium) was first distilled from its original storage vessel and transferred onto calcium hydride for a minimum of half an hour to remove moisture. EO was then distilled onto approximately 0.02 eq. of di-n-butylmagnesium and allowed to stir for a minimum of a half an hour, prior to transfer to a sealed buret. The purified EO was connected to the living PS− solution via a cannula, allowing its vapor phase diffusion to the living styrene solution. The reaction was allowed to proceed for a minimum of two hours and was then terminated with acidic methanol (1 mL fuming HCl/10 mL of methanol).

The PS-OH solution was repeatedly washed with saturated sodium bicarbonate solution and distilled water pH neutral. The polymer was recovered by precipitation in methanol and washed until material became brittle and easily broken by impact with a spatula. The material was then dried under vacuum until all traces of cyclohexane and methanol have been removed. GPC analysis was used to determine the molecular weight distribution.

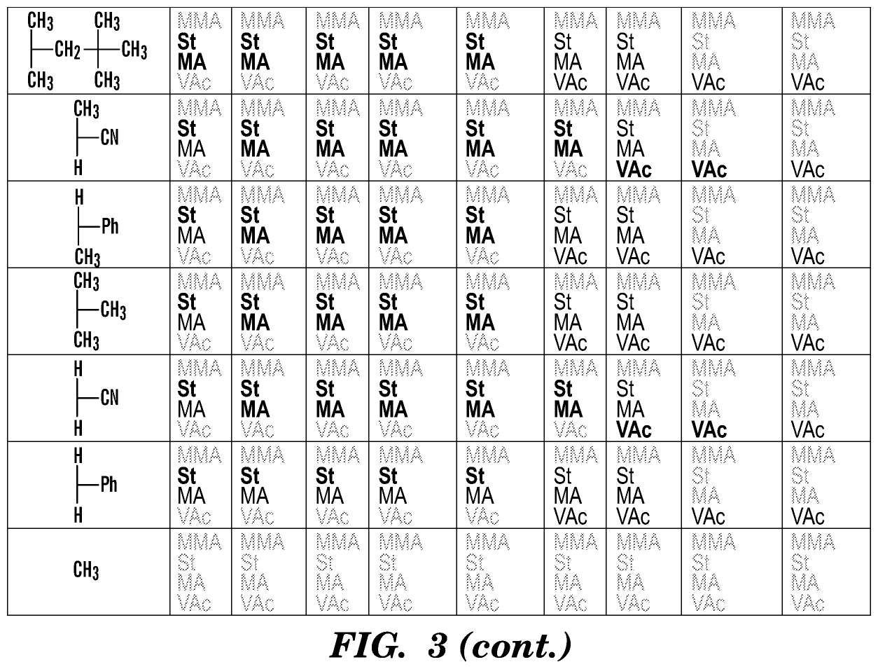

NMR was used to determine a rough estimate of the number of chains that have been capped with ethylene oxide. Comparing the integration of I_{OH}≡∫_{3.0}^{3.5} S(δ)dδ to the integration of I_{Ar}≡∫_{6.2}^{7.4} S(δ) dδ one can determine the number of protons adjacent to the alcohol and the number of protons on the aromatic repeat unit (FIG. 4). Setting the protons adjacent to the alcohol to one gives conversion via the following formula.

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{181 * \frac{2}{5} * 104} = 132 \%$$

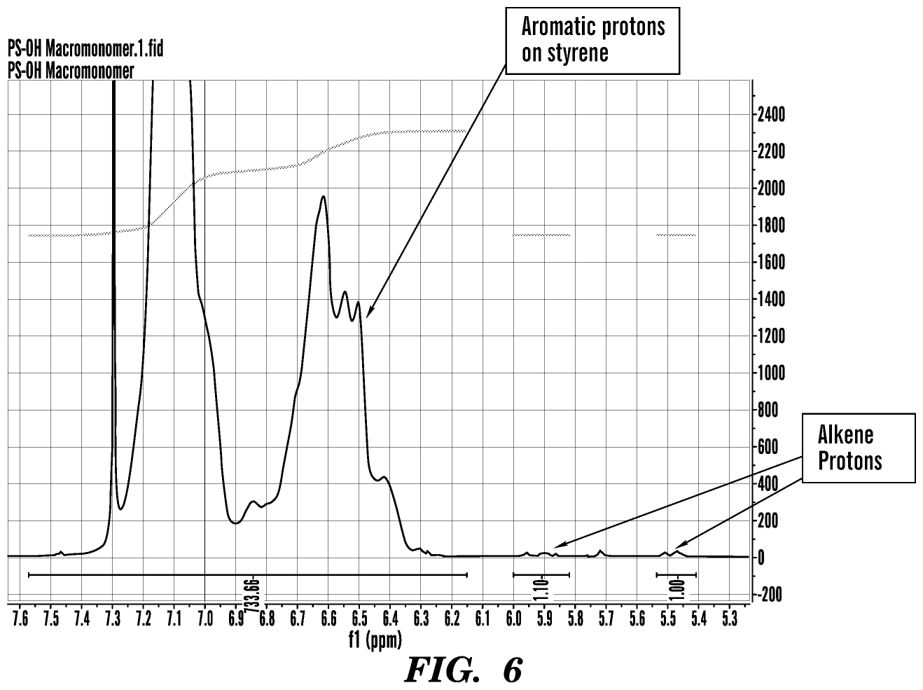

This higher than 100% conversion result can be attributed to two factors: inaccuracy in NMR resolution or inaccuracy in GPC standards. This does clearly prove that there are substantial amounts of alcohol end groups present. Additionally, the GPC does show a slight increase in molecular weight when the PS-OH is compared with a PS aliquot (FIG. 7).

Tert-bromine Capping

To add tertiary halogen functionality, 2-bromo-2-methylpropanoyl bromide was purchased from Sigma Aldrich. PS-OH (10 grams) was added to a round bottom flask with 200 mL of cyclohexane and a stir bar. The PS-OH was allowed to dissolve and then trimethylamine (10 eq (with respect to chain ends)) was added to the flask. Finally, 2-bromo-2-methylpropanoyl bromide (10 eq (also with respect to chain ends)) was added to the flask slowly over 5 minutes. The reaction was then warmed to 40° C. and allowed to react 12 hours.

The solution was slowly poured into methanol and then the precipitate was collected and further washed with methanol until brittle. The polymer was then dried under reduced pressure to remove all traces of solvent. Additionally, the polymer was run through GPC to determine molecular weight.

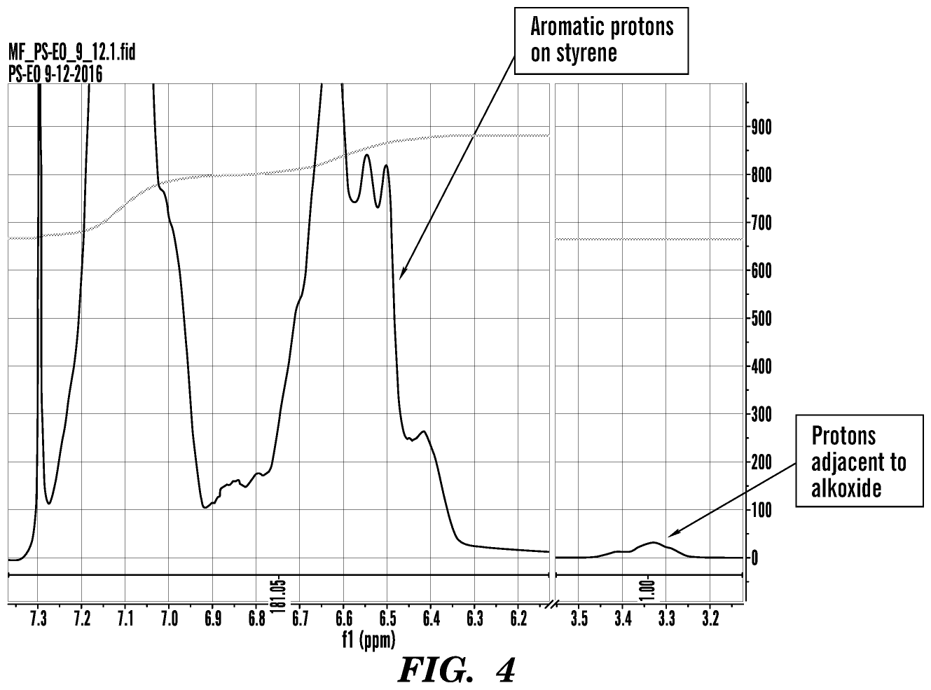

NMR was used to determine a rough estimate of the number of chains that have been capped with the tertiary bromine. While the NMR clearly showed the methyl peak corresponding to the dimethyl it was engulfed in the backbone protons of the polymer. As such the protons adjacent to the ester group was used to determine the amount of tert-bromine present. Comparing the integration of I_{TBr}=∫_{3.7}^{3.8} S(δ)dδ to the integration of I_{TBr}=∫_{3.7}^{3.8} S(δ)dδ one can determine the number of protons adjacent to the ester and the number of protons on the aromatic repeat unit (FIG. 5).

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{166 * \frac{2}{5} * 104} = 144 \%$$

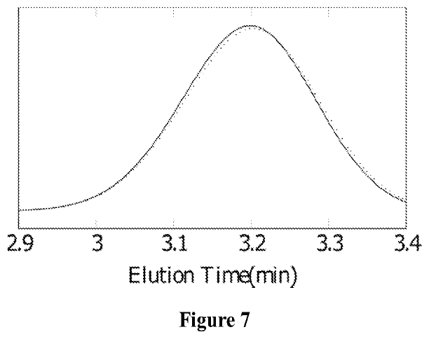

As before, the above 100% calculated conversion was likely from inaccuracy in NMR resolution or inaccuracy in GPC standards. Additionally the GPC did show a slight increase in molecular weight when the PS-Br was compared to the PS-OH (FIG. 8).

Macro-CTA Functionality

In order to provide macro-CTA functionality, bis thiobenzoyl disulfide and N,N,N′,N″,N″-pentamethyldiethylenetriamine (PMDTA) were purchased from Sigma Aldrich. Additionally, copper (I) bromide and copper wire were purchased from Fisher Scientific. PS-T-Halogen (1 g) was dissolved in toluene (5 g). Bis dithioate (2 eq), copper (I) bromide (0.1 eq), and copper wire (10 eq) were dissolved in toluene and PMDTA (5 eq) was added in order to create the copper complex. The solution was bubbled with argon for 15 minutes before PS-T-Halogen solution is added. The reaction was allowed to proceed at 80° C. overnight.

Upon completion of the reaction, the polymer solution was passed through a silica column to remove most of the copper. The solution was then precipitated and doubly dissolved and precipitated into methanol. The polymer was then washed with methanol until brittle and then dried under vacuum overnight. A sample of the polymer was then collected to run GPC to determine molecular weight.

Block Copolymer of Macro-CTA

PS-D-CTA (0.1 g), toluene (1 g), butyl acrylate (0.4 g), and AIBN (0.000492 g) were added to a flask and purged for ten minutes. The flask was then heated to 80° C. for an hour. Upon completion of the reaction, the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yields the conversion.

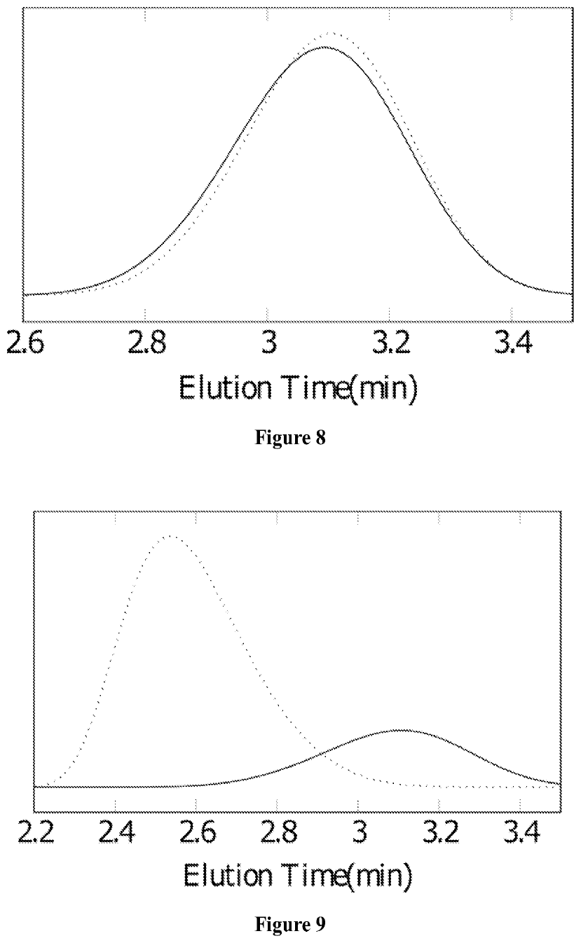

The success of the ATR reaction was determined by co-blocking the styrene with NBA and comparing the integration of the grown polymer to the integration of the non-grown polymer. This allowed for the calculation of end-capping efficiency. After three duplications, the conversion was determined to be 80%, 82%, and 87% (FIG. 9).

### Example 2—Production of Macro-CTA Using ATR Method Coupled with ARGET Reduction of Copper

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passing through an activated alumina column. HPLC grade cyclohexane (CHX) was purchased from Fisher Scientific and purified by inerting with argon and then passing through an oxygen scavenging column (Engelhard q5) and an activated alumina column.

CHX (500 mL) was added to an argon-filled round bottom flask equipped with a stir bar. The flask was then heated to 40° C. in a water bath. Sec-butyllithium solution (4.5 mL) (targeting an 8 kDa polymer) was added. Styrene (50 g) was introduced slowly over the course of 30 minutes to limit the temperature increase due to the exothermic nature of the polymerization. Finally, an aliquot was taken in order to determine the molecular weight of the polymer prior to further modification. The aliquot was processed by the GPC and showed a molecular weight of 10 kDa.

Ethylene Oxide Capping

Next, while the styrene was still living, ethylene oxide was used to provide a primary alcohol at the end of the styrene chain. This was done according to established procedures (Epps T. H., “Locating Network Phases in Linear ABC Triblock Copolymers,” University of Minnesota, Thesis (2004), which is hereby incorporated by reference in its entirety). Ethylene oxide (EO) was purchased from Sigma Aldrich and triple purified: The ethylene oxide (minimum of 10 molar excess with respect to sec-butyllithium) was first distilled from its original storage vessel and transferred onto calcium hydride for a minimum of half an hour to remove moisture. EO was then distilled onto approximately 0.02 eq. of di-n-butylmagnesium and allowed to stir for a minimum of a half an hour, prior to transfer to a sealed buret. The purified EO was connected to the living PS− solution via a cannula, allowing its vapor phase diffusion to the living styrene solution. The reaction was allowed to proceed for a minimum of two hours and was then terminated with acidic methanol (1 mL fuming HCl/10 mL of methanol).

The PS-OH solution was repeatedly washed with saturated sodium bicarbonate solution and distilled water pH neutral. The polymer was recovered by precipitation in methanol and washed until the material becomes brittle and easily broken by impact with a spatula. The material was then dried under vacuum until all traces of cyclohexane and methanol have been removed. GPC analysis was used to determine the molecular weight distribution.

NMR is used to determine a rough estimate of the number of chains that have been capped with ethylene oxide. Comparing the integration of I_{OH}≡∫_{3.0}^{3.5} S(δ)dδ, to the integration of I_{Ar}≡∫_{6.2}^{7.4} S(δ) dδ one can determine the number of protons adjacent to the alcohol and the number of protons on the aromatic repeat unit (FIG. 4). Setting the protons adjacent to the alcohol to one gives conversion via the following formula.

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{181 * \frac{2}{5} * 104} = 132 \%$$

This higher than 100% conversion result can be attributed to two factors: inaccuracy in NMR resolution, or inaccuracy in GPC standards. This clearly proves that there are substantial amounts of alcohol end groups present. Additionally, the GPC shows a slight increase in molecular weight when the PS-OH is compared with a PS aliquot (FIG. 7).

Tert-Bromine Capping

To add tertiary halogen functionality, 2-bromo-2-methylpropanoyl bromide was purchased from Sigma Aldrich. PS-OH (10 g) was added to a round bottom flask with cyclohexane (200 mL) and a stir bar. The PS-OH was allowed to dissolve and then trimethylamine (10 eq (with respect to chain ends)) was added to the flask. Finally, 2-bromo-2-methylpropanoyl bromide (10 eq (also with respect to chain ends)) was added to the flask slowly over 5 minutes. The reaction was then warmed to 40° C. and allowed to react 12 hours.

The solution was slowly poured into methanol and then the precipitate was collected and further washed with methanol until brittle. The polymer was then dried under reduced pressure to remove all traces of solvent. Additionally the polymer was run through GPC to determine molecular weight.

NMR was used to determine a rough estimate of the number of chains that have been capped with the tertiary bromine. While the NMR clearly showed the methyl peak corresponding to the dimethyl, it is engulfed in the backbone protons of the polymer. As such, the protons adjacent to the ester group were used to determine the amount of tert bromine present. Comparing the integration of I_{TBr}=∫_{3.7}^{3.8} S(δ)dδ to the integration of .I_{TBr}=∫_{3.7}^{3.8} S(δ)dδ, one can determine the number of protons adjacent to the ester and the number of protons on the aromatic repeat unit (FIG. 5).

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{166 * \frac{2}{5} * 104} = 144 \%$$

As before, the above 100% calculated conversion was likely from inaccuracy in NMR resolution or inaccuracy in GPC standards. Additionally, the GPC showed a slight increase in molecular weight when the PS-Br is compared to the PS-OH (FIG. 8).

Macro-CTA Functionality

In order to provide macro-CTA functionality, bis thiobenzoyl disulfide and N,N,N′,N″,N″-pentamethyldiethylenetriamine (PMDTA) were purchased from Sigma Aldrich. Additionally, copper (II) bromide was purchased from Fisher Scientific. PS-T-Halogen (1 g) was dissolved in toluene (5 g). Copper (II) bromide (0.3 eq) was dissolved in toluene, and PMDTA (5 eq) was added in order to create the copper complex. The solution was bubbled with argon for 15 minutes before PS-T-halogen solution was added to the copper complex solution. Then, tin(II) ethyl hexanoate (0.3 eq) was added and allowed to stir for a half an hour. Next, bis phenyldithioate (0.3 eq) was added and allowed to stir for a half an hour. This was repeated three times. The purpose for this alternating tin and sulfur route is that the tin(II) ethylhexanoate is a powerful enough reducing agent to have undesired side reactions with the dithioate molecule.

Upon completion of the reaction, the polymer solution was passed through a silica column to remove most of the copper. The solution was then precipitated and doubly dissolved and precipitated into methanol. The polymer was then washed with methanol until brittle and then dried under vacuum overnight. A sample of the polymer was then collected to run GPC to determine molecular weight.

Block Copolymer of Macro-CTA

PS-D-CTA (0.1 g), toluene (1 g), butyl acrylate (0.4 g), and of AIBN (0.000492 g) were added to a flask and purged for ten minutes. The flask was then heated to 80° C. for an hour. Upon completion of the reaction, the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yielded the conversion.

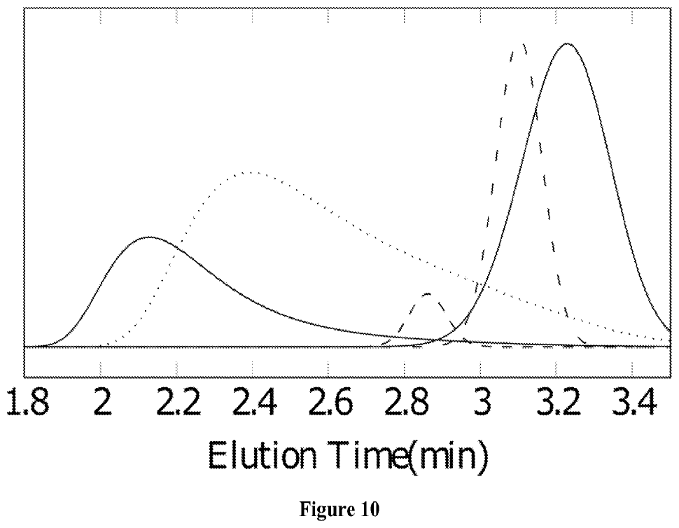

The success of the ATR reaction was determined by co-blocking the styrene with NBA and comparing the integration of the grown polymer to the integration of the non-grown polymer. This allowed for the calculation of end-capping efficiency. The results of this experiment gave 55% macro-CTA that was converted to block copolymer as shown in FIG. 10.

### Example 3—Production of Macro-CTA Using ATR Method Coupled with Metal Free Methods

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passing through an activated alumina column. HPLC grade cyclohexane (CHX) was purchased from Fisher Scientific and purified by inerting with argon and then passing through an oxygen scavenging column (Engelhard q5) and an activated alumina column.

500 mL of CHX was added to an argon-filled round bottom flask equipped with a stir bar. The flask was then heated to 40° C. in a water bath. Sec-butyllithium solution (4.5 mL) (targeting an 8 kDa polymer) was added. Styrene (50 g) was introduced slowly over the course of 30 minutes to limit the temperature increase due to the exothermic nature of the polymerization. Finally, an aliquot was taken in order to determine the molecular weight of the polymer prior to further modification. The aliquot when processed by the GPC showed a molecular weight of 10 kDa.

Ethylene Oxide Capping

Next, while the styrene was still living ethylene oxide was used to provide a primary alcohol at the end of the styrene chain. This was done according to established procedures (Epps T. H., “Locating Network Phases in Linear ABC Triblock Copolymers,” University of Minnesota, Thesis (2004), which is hereby incorporated by reference in its entirety). Ethylene oxide (EO) was purchased from Sigma Aldrich and triple purified: The ethylene oxide (minimum of 10 molar excess with respect to sec-butyllithium) was first distilled from its original storage vessel and transferred onto calcium hydride for a minimum of half an hour to remove moisture. EO was then distilled onto approximately 0.02 eq. of di-n-butylmagnesium and allowed to stir for a minimum of a half an hour, prior to transfer to a sealed buret. The purified EO was connected to the living PS− solution via a cannula, allowing its vapor phase diffusion to the living styrene solution. The reaction was allowed to proceed for a minimum of two hours and was then terminated with acidic methanol (1 mL fuming HCl/10 mL of methanol).

The PS-OH solution was repeatedly washed with saturated sodium bicarbonate solution and distilled water pH neutral. The polymer was recovered by precipitation in methanol and washed until material become brittle and easily broken by impact with a spatula. The material was then dried under vacuum until all traces of cyclohexane and methanol have been removed. GPC analysis was used to determine the molecular weight distribution.

NMR was used to determine a rough estimate of the number of chains that have been capped with ethylene oxide. The number of protons adjacent to the alcohol and the number of protons on the aromatic repeat unit was determined by comparing the integration of I_{OH}≡∫3.0^{3.5} S(δ)dδ to the integration of I_{Ar}≡∫_{6.2}^{7.4} S(δ) dδ (FIG. 4). Setting the protons adjacent to the alcohol to one gave conversion via the following formula.

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{181 * \frac{2}{5} * 104} = 132 \%$$

This higher than 100% conversion result can be attributed to two factors: inaccuracy in NMR resolution, or inaccuracy in GPC standards. This does clearly prove that there are substantial amounts of alcohol end groups present. Additionally the GPC does show a slight increase in molecular weight when the PS-OH is compared with a PS aliquot (FIG. 7).

Tert-Bromine Capping

To add tertiary halogen functionality, 2-bromo-2-methylpropanoyl bromide was purchased from Sigma Aldrich. PS-OH (10 gr) was added to a round bottom flask with cyclohexane (200 mL) and a stir bar. The PS-OH was allowed to dissolve and then trimethylamine (10 eq (with respect to chain ends)) was added to the flask. Finally, 2-bromo-2-methylpropanoyl bromide (10 eq (also with respect to chain ends)) was added to the flask slowly over 5 minutes. The reaction was then warmed to 40° C. and allowed to react 12 hours.

The solution was slowly poured into methanol and then the precipitate was collected and further washed with methanol until brittle. The polymer was then dried under reduced pressure to remove all traces of solvent. Additionally, the polymer was run through GPC to determine molecular weight.

NMR was used to determine a rough estimate of the number of chains that have been capped with the tertiary bromine. While the NMR clearly showed the methyl peak corresponding to the dimethyl, it is engulfed in the backbone protons of the polymer. As such the protons adjacent to the ester group was used to determine the amount of tert bromine present. The number of protons adjacent to the ester and the number of protons on the aromatic repeat unit was determined by comparing the integration of I_{TBr}=∫_{3.7}^{3.8} S(δ)dδ to the integration of .I_{TBr}=∫_{3.7}^{3.8} S(δ)dδ (FIG. 5).

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{166 * \frac{2}{5} * 104} = 144 \%$$

As before, the above 100% calculated conversion was likely from inaccuracy in NMR resolution or inaccuracy in GPC standards. Additionally the GPC did show a slight increase in molecular weight when the PS-Br was compared to the PS-OH (FIG. 8).

Macro-CTA Functionality

In order to provide macro-CTA functionality, bis thiobenzoyl disulfide and 10 methylphenothiazine were purchased from Sigma Aldrich. Polymer (1 g) was dissolved in anisole and bis thiobenzoyl disulfide (5 eq) and methylphenothiazine (5 eq) were added to the solution. The reaction was bubbled for 15 minutes prior to stirring the reaction for 20 hours while being subjected to 254 nm wavelength light.

Block Copolymer of Macro-CTA

PS-D-CTA (0.1 g), toluene (1 g), butyl acrylate (0.4 g), and AIBN (0.000492 g) were added to a flask and purged for ten minutes. The flask was then heated to 80° C. for an hour. Upon completion of the reaction the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yielded the conversion.

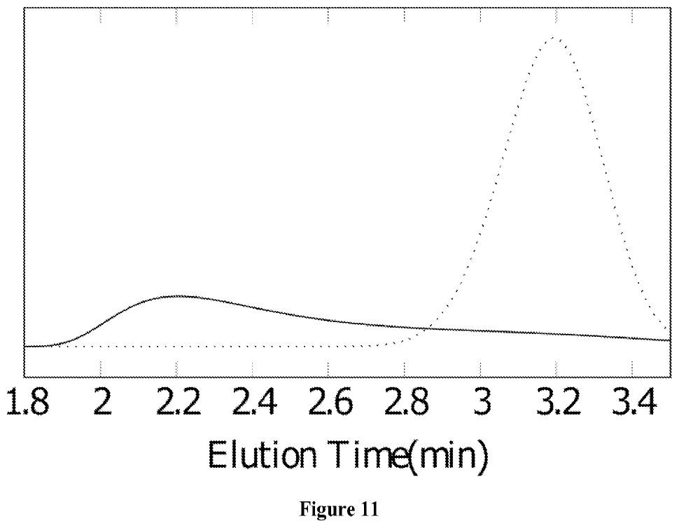

The success of the ATR reaction was determined by co-blocking the styrene with NBA and comparing the integration of the grown polymer to the integration of the non-grown polymer. This allowed for the calculation of end-capping efficiency. The results of this experiment gave 28% macro-CTA that was converted to block copolymer as shown in FIG. 11.

### Example 4—Production of Macro-CTA Using ATR Method Coupled with One Step Synthesis to Tert-Bromine Using Weinreb Reagent

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passing through an activated alumina column. HPLC grade cyclohexane (CHX) was purchased from Fisher Scientific and purified by inerting with argon and then passing through an oxygen scavenging column (Engelhard q5) and an activated alumina column.

500 mL of CHX was added to an argon-filled round bottom flask equipped with a stir bar. The flask is then heated to 40° C. in a water bath. Sec-butyllithium solution (4.5 mL) (targeting an 8 kDa polymer) was added. Styrene (50 g) was introduced slowly over the course of 30 minutes to limit the temperature increase due to the exothermic nature of the polymerization. Finally, an aliquot was taken in order to determine the molecular weight of the polymer prior to further modification. The aliquot was when processed by the GPC and showed a molecular weight of 10 kDa.

Weinreb Amide Synthesis

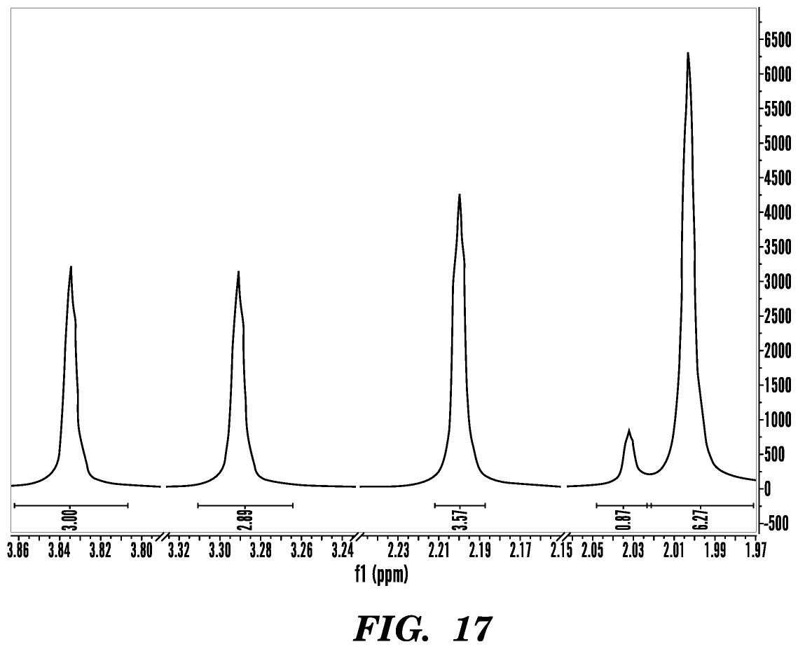

In order to directly cap an anionic polymer with a tert-bromine functionality, a weinreb amide was synthesized (FIG. 2). N,O-Dimethylhydroxylamine hydrochloride (1 eq) was added to dichloromethane to make 5% mass solution. Trimethylamine (1 eq) was added slowly. Finally, alpha-bromoisobutyryl bromide (3 eq) was added slowly and the reaction was allowed to stir for 20 hours. Upon completion of the reaction, the solid was filtered off and the filtrate was washed with sodium bicarbonate, sodium hydroxide, and then brine. Finally, the solvent was removed under reduced pressure and NMR was taken to confirm the structure. The NMR showed the peaks as expected (3H, δ3.84; 3H, δ3.29; 6H δ2.00) and the impurity of the original carboxylic acid at δ2.03 (FIG. 17).

Capping PS with Tert-Bromine Weinreb

The Weinreb synthesized in the previous step was stirred over calcium hydride in cyclohexane for 16 hours before use. The solution was bubbled with argon and then injected directly into the living polystyrene reaction in excess (˜10 eq).

Macro-CTA Functionality

In order to provide macro-CTA functionality, bis thiobenzoyl disulfide and N,N,N′,N″,N″-pentamethyldiethylenetriamine (PMDTA) were purchased from Sigma Aldrich. Additionally, copper (II) bromide was purchased from Fisher Scientific. PS-T-Halogen (1 g) was dissolved in toluene (5 g). Copper (II) bromide (0.3 eq) was dissolved in toluene (5 mL), and PMDTA (5 eq) was added in order to create the copper complex. The solution was bubbled with argon for 15 minutes before PS-T-halogen solution was added to the copper complex solution. Then, tin(2) ethyl hexanoate (0.3 eq) was added and allowed to stir for a half an hour. Next, bis phenyldithioate (0.3 eq) was added and allowed to stir for a half an hour. This was repeated three times. The reason for this alternating tin and sulfur route was that the tin(II) ethylhexanoate is a powerful enough reducing agent to have undesired side reactions with the dithioate molecule.

Upon completion of the reaction, the polymer solution was passed through a silica column to remove most of the copper. The solution was then precipitated and doubly dissolved and precipitated into methanol. The polymer was then washed with methanol until brittle and then dried under vacuum overnight. A sample of the polymer was collected to run GPC to determine molecular weight.

Block Copolymer of Macro-CTA

PS-D-CTA (0.1 g), toluene (1 g), butyl acrylate (0.4 g), and of AIBN (0.000492 g) were added to a flask and purged for ten minutes. The flask was then heated to 80° C. for an hour. Upon completion of the reaction the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yielded the conversion.

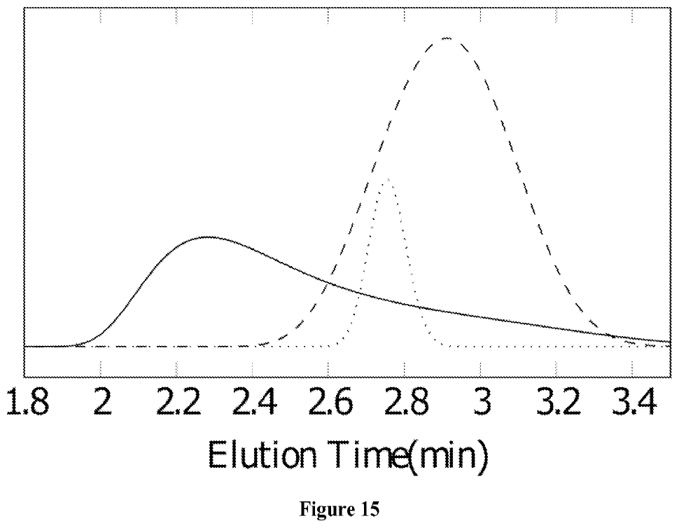

The success of the ATR reaction was determined by co-blocking the styrene with NBA and comparing the integration of the grown polymer to the integration of the non-grown polymer. This allowed for the calculation of end-capping efficiency. The results of this experiment showed that 32% of macro-CTA that was converted to block copolymer as shown in FIG. 15.

### Example 5—Production of Macro-CTA Using Macromonomer Method with Methacrylic Anhydride

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passing through an activated alumina column. HPLC grade cyclohexane (CHX) was purchased from Fisher Scientific and purified by inerting with argon and then passing through an oxygen scavenging column (Engelhard q5) and an activated alumina column.

500 mL of CHX was added to an argon-filled round bottom flask equipped with a stir bar. The flask is then heated to 40° C. in a water bath. Sec-butyllithium solution (4.5 mL) (targeting an 8 kDa polymer) was added. Styrene (50 g) was introduced slowly over the course of 30 minutes to limit the temperature increase due to the exothermic nature of the polymerization. Finally, an aliquot was taken in order to determine the molecular weight of the polymer prior to further modification. The aliquot when processed by the GPC and showed a molecular weight of 10 kDa.

Ethylene Oxide Capping

Next, while the styrene was still living, ethylene oxide was used to provide a primary alcohol at the end of the styrene chain. This was done according to established procedures (Epps T. H., “Locating Network Phases in Linear ABC Triblock Copolymers,” University of Minnesota, Thesis (2004), which is hereby incorporated by reference in its entirety). Ethylene oxide (EO) was purchased from Sigma Aldrich and triple purified. The ethylene oxide (minimum of 10 molar excess with respect to sec-butyllithium) was first distilled from its original storage vessel and transferred onto calcium hydride for a minimum of half an hour to remove moisture. EO was then distilled onto approximately di-n-butylmagnesium (0.02 eq.) and allowed to stir for a minimum of a half an hour, prior to transfer to a sealed buret. The purified EO was connected to the living PS solution via a cannula, allowing its vapor phase diffusion to the living styrene solution. The reaction was allowed to proceed for a minimum of two hours and was then terminated with acidic methanol (1 mL fuming HCl/10 mL of methanol).

The PS-OH solution was repeatedly washed with saturated sodium bicarbonate solution and distilled water pH neutral. The polymer was recovered by precipitation in methanol and washed until material becomes brittle and easily broken by impact with a spatula. The material was then dried under vacuum until all traces of cyclohexane and methanol have been removed. GPC analysis was used to determine the molecular weight distribution.

NMR was used to determine a rough estimate of the number of chains that have been capped with ethylene oxide. The number of protons adjacent to the alcohol and the number of protons on the aromatic repeat unit was determined by comparing the integration of I_{OH}≡∫_{3.0}^{3.5} S(δ)dδ to the integration of I_{Ar}≡∫_{6.2}^{7.4} S(δ) dδ (FIG. 4). Setting the protons adjacent to the alcohol to one gives conversion via the following formula.

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{181 * \frac{2}{5} * 104} = 132 \%$$

This higher than 100% conversion result that we are getting can be attributed to two factors: inaccuracy in NMR resolution, or inaccuracy in GPC standards. This clearly proves that there are substantial amounts of alcohol end groups present. Additionally the GPC shows a slight increase in molecular weight when the PS-OH is compared with a PS aliquot (FIG. 7).

Methacrylate Functionality Capping

In order to place the methacrylate functionality onto the anionicly grown polymer, 1 g of the polymer was dissolved in cyclohexane and 10 eq of trimethylamine were added to the solution. Then, methacrylic anhydride was added at room temperature and then the temperature was raised to 55° C. for 20 hours. Upon completion of the reaction, the solution was then precipitated and washed with methanol until the polymer becomes brittle. The polymer was then tested with NMR and GPC in order to determine functionality and molecular weight.

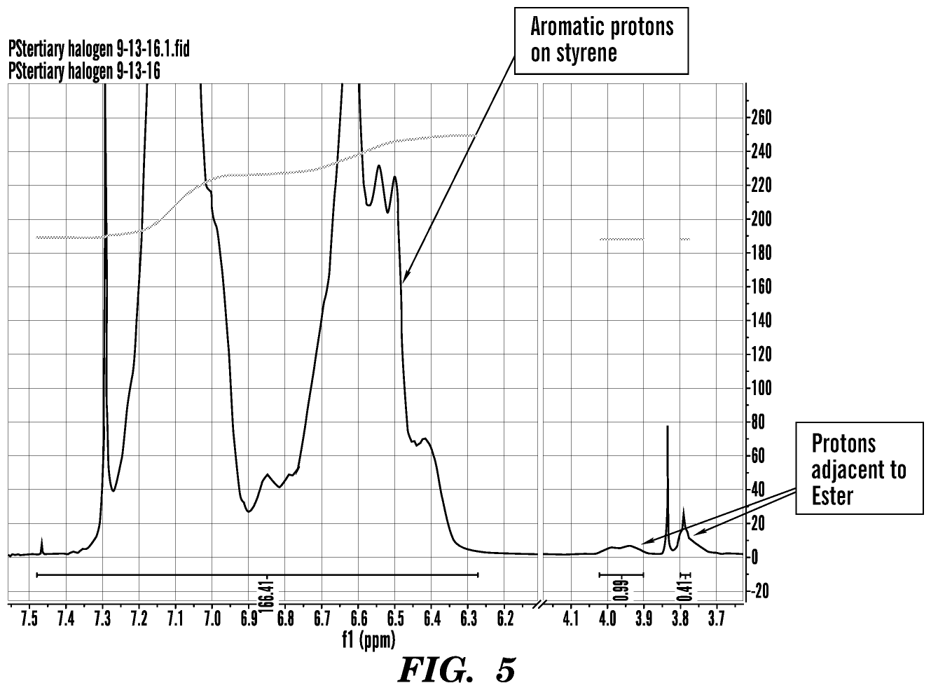

NMR is used to determine the number of methacrylic groups added onto the PS-OH. Integrating between ∫_{5.4}^{5.6} (δ)dδ setting the integral to 1 and comparing to the integral f_{6.2}^{7.5} (δ)dδ (FIG. 6) with the formula below will give you the percent methacrylation.

$$\frac{{PS}_{molweight}}{{\int }_{6.2}^{7.4} S ( δ ) d δ * \frac{alkene protons}{aromatic protons} * Mn Styrene} = \frac{10000}{733 * \frac{1}{5} * 104} = 66 \%$$

Macro-CTA Functionality

1 g of PS-MM was added with 2 g of toluene to a flask. Methacrylate compatible CTA (2-cyanopropan-2-yl ethyl carbonotrithioate (3.0 eq)-synthesized by well established procedures) was added to the flask with 1 equivalent of AIBN. All equivalents are with respect to chain ends. The reaction was bubbled with argon for 15 minutes and then reacted for four hours. Upon completion of this reaction, the polymer was precipitated and washed in methanol until a brittle solid. The sample was then run on GPC to determine the molecular weight.

Block Copolymer of Macro-CTA

0.1 g of PS-T-CTA, 1 g of toluene, 0.4 g of butyl acrylate, and 0.000492 g of AIBN were added to a flask and purged for ten minutes. The flask was then heated to 80° C. for an hour. Upon completion of the reaction, the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yielded the conversion.

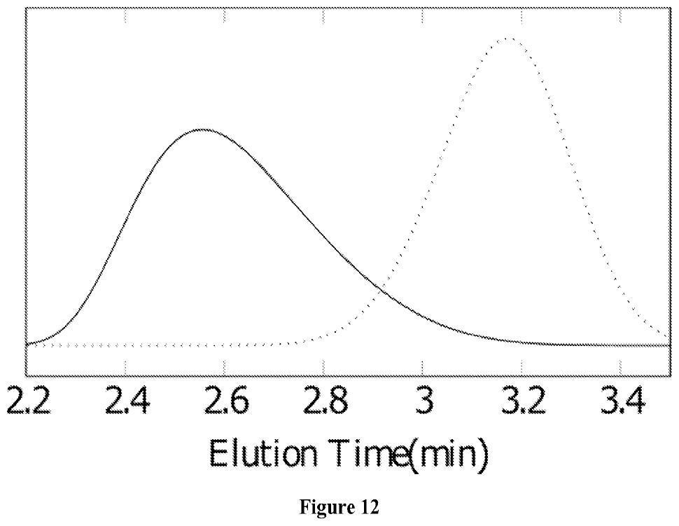

The success of the macromonomer to macro CTA conversion was determined by co-blocking styrene with NBA (N-butyl acrylate) and comparing the integration of the grown polymer to the integration of the non-grown polymer. This allowed for the calculation of end-capping efficiency. 50% conversion was achieved (FIG. 12), but after taking into account that not all of the ethylene oxide capped polymer was converted to methacrylate (a problem that can be remedied with more time, heat, or using methacryloyl chloride), 75-80% of the macromonomer to macro-CTA conversion was achieved.

### Example 6—Production of Macro-CTA Using Macromonomer Method with Methacryloyl Chloride

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passing through an activated alumina column. HPLC grade cyclohexane (CHX) was purchased from Fisher Scientific and purified by inerting with argon and then passing through an oxygen scavenging column (Engelhard q5) and an activated alumina column.

Cyclohexane (500 mL) was added to an argon-filled round bottom flask equipped with a stir bar. The flask was then heated to 40° C. in a water bath. Sec-butyllithium solution (4.5 mL) (targeting an 8 kDa polymer) was added. Styrene (50 g) was introduced slowly over the course of 30 minutes to limit the temperature increase due to the exothermic nature of the polymerization. Finally, an aliquot was taken in order to determine the molecular weight of the polymer prior to further modification. The aliquot when processed by the GPC shows a molecular weight of 10 kDa.

Ethylene Oxide Capping

Next, while the styrene is still living, ethylene oxide was used to provide a primary alcohol at the end of the styrene chain. This is done according to established procedures (Epps T. H., “Locating Network Phases in Linear ABC Triblock Copolymers,” University of Minnesota, Thesis (2004), which is hereby incorporated by reference in its entirety). Ethylene oxide (EO) was purchased from Sigma Aldrich and triple purified. The ethylene oxide (minimum of 10 molar excess with respect to sec-butyllithium) was first distilled from its original storage vessel and transferred onto calcium hydride for a minimum of half an hour to remove moisture. EO was then distilled onto approximately 0.02 eq. of di-n-butylmagnesium and allowed to stir for a minimum of a half an hour, prior to transfer to a sealed buret. The purified EO was connected to the living PS− solution via a cannula, allowing its vapor phase diffusion to the living styrene solution. The reaction was allowed to proceed for a minimum of two hours and was then terminated with acidic methanol (1 mL fuming HCl/10 mL of methanol).

The PS-OH solution was repeatedly washed with saturated sodium bicarbonate solution and distilled water pH neutral. The polymer was recovered by precipitation in methanol and washed until material becomes brittle and easily broken by impact with a spatula. The material was then dried under vacuum until all traces of cyclohexane and methanol have been removed. GPC analysis was used to determine the molecular weight distribution.

NMR was used to determine a rough estimate of the number of chains that have been capped with ethylene oxide. Comparing the integration of I_{OH}≡∫_{3.0}^{3.5} S(δ)dθ to the integration of I_{Ar}≡∫6.2^{7.4} S(δ) dδ, one can determine the number of protons adjacent to the alcohol and the number of protons on the aromatic repeat unit (FIG. 4). Setting the protons adjacent to the alcohol to one gives conversion via the following formula.

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{181 * \frac{2}{5} * 104} = 132 \%$$

This higher than 100% conversion result can be attributed to two factors: inaccuracy in NMR resolution, or inaccuracy in GPC standards. This clearly proves that there are substantial amounts of alcohol end groups present. Additionally the GPC shows a slight increase in molecular weight when the PS-OH is compared with a PS aliquot (FIG. 7).

Methacrylate Functionality Capping

In order to place the methacrylate functionality onto the anionicly grown polymer, 1 g of the polymer was dissolved in cyclohexane and 10 eq of trimethylamine were added to the solution. Then, 10 eq of methacryloyl chloride was added at room temperature and then the temperature was raised to 40° C. for 20 hours. Upon completion of the reaction, the solution was precipitated and washed with methanol until the polymer became brittle. The polymer was then tested with NMR and GPC in order to determine functionality and molecular weight.

NMR was used to determine the number of methacrylic groups added onto the PS-OH. Integrating between ∫_{5.4}^{5.6}(δ)dδ setting the integral to 1 and comparing to the integral ∫_{6.2}^{7.5}(δ)dδ with the formula below will give the percent methacrylation.

$$\frac{{PS}_{molweight}}{{\int }_{6.2}^{7.4} S ( δ ) d δ * \frac{alkene protons}{aromatic protons} * Mn Styrene} = \frac{10000}{450 * \frac{1}{5} * 104} = 106 \%$$

Macro-CTA Functionality

1 g of PS-MM was added with 2 g of toluene to a flask. Methacrylate compatible CTA (2-cyanopropan-2-yl ethyl carbonotrithioate (3.0 eq.) synthesized by well established procedures) was added to the flask with 1 equivalent of azobisisobutyronitrile (AIBN). All equivalents were with respect to chain ends. The reaction was bubbled with argon for 15 minutes and then reacted at 80° C. for four hours. Upon completion of this reaction, the polymer was precipitated and washed in methanol until a brittle solid. The sample was then run on GPC to determine the molecular weight.

An additional experiment was conducted to determine what time gives ideal conversions. At 80° C., 20 minutes gives substantially higher conversions than longer times (Table 1).

TABLE 1
Conversion vs. Time for Macromonomer

| Time (minutes) | % block copolymer |
|---|---|
| 20 | 78% |
| 40 | 72% |
| 65 | 69% |
| 120 | 54% |

Block Copolymer of Macro-CTA

0.1 g of PS-T-CTA, 1 g of toluene, 0.4 g of butyl acrylate, and 0.000492 g of AIBN were added to a flask and purged for ten minutes. The flask was then heated to 80° C. for an hour. Upon completion of the reaction, the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yields the conversion.

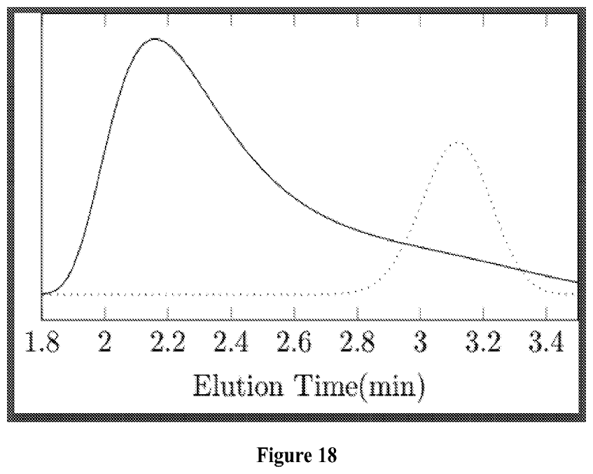

The success of the macromonomer to macro CTA conversion was determined by co-blocking styrene with NBA and comparing the integration of the grown polymer to the integration of the non-grown polymer. This allowed for the calculation of end-capping efficiency. 80% conversion was achieved (FIG. 18).

### Example 7—Production of Macro-CTA Using Macroinitiator Method with 4,4′-Azobis(4-Cyanovaleric Acid)

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passage through an activated alumina column. HPLC grade cyclohexane (CHX) was purchased from Fisher Scientific and purified by inerting with argon and then passing through an oxygen scavenging column (Engelhard q5) and an activated alumina column.

CHX (500 mL) was added to an argon-filled round bottom flask equipped with a stir bar. The flask was then heated to 40° C. in a water bath. Sec-butyllithium solution (4.5 mL) (targeting an 8 kDa polymer) was added. Styrene (50 g) was introduced slowly over the course of 30 minutes to limit the temperature increase due to the exothermic nature of the polymerization. Finally, an aliquot was taken in order to determine the molecular weight of the polymer prior to further modification. The aliquot when processed by the GPC showed a molecular weight of 10 kDa.

Ethylene Oxide Capping

Next, while the styrene is still living, ethylene oxide was used to provide a primary alcohol at the end of the styrene chain. This was done according to established procedures (Epps T. H., “Locating Network Phases in Linear ABC Triblock Copolymers,” University of Minnesota, Thesis (2004), which is hereby incorporated by reference in its entirety). Ethylene oxide (EO) was purchased from Sigma Aldrich and triple purified. The ethylene oxide (minimum of 10 molar excess with respect to sec-butyllithium) was first distilled from its original storage vessel and transferred onto calcium hydride for a minimum of half an hour to remove moisture. EO was then distilled onto approximately 0.02 eq. of di-n-butylmagnesium and allowed to stir for a minimum of a half an hour, prior to transfer to a sealed buret. The purified EO was connected to the living PS− solution via a cannula, allowing its vapor phase diffusion to the living styrene solution. The reaction was allowed to proceed for a minimum of two hours and then terminated with acidic methanol (1 mL fuming HCl/10 mL of methanol).

The PS-OH solution was repeatedly washed with saturated sodium bicarbonate solution and distilled water pH neutral. The polymer was recovered by precipitation in methanol and washed until material became brittle and easily broken by impact with a spatula. The material was then dried under vacuum until all traces of cyclohexane and methanol have been removed. GPC analysis was used to determine the molecular weight distribution.

NMR was used to determine a rough estimate of the number of chains that have been capped with ethylene oxide. Comparing the integration of I_{OH}≡∫_{3.0}^{3.5} S(δ)dδ to the integration of I_{Ar}≡∫_{6.2}^{7.4} S(δ) dδ one can determine the number of protons adjacent to the alcohol and the number of protons on the aromatic repeat unit (FIG. 4). Setting the protons adjacent to the alcohol to one gives conversion via the following formula.

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{181 * \frac{2}{5} * 104} = 132 \%$$

This higher than 100% conversion result can be attributed to two factors: inaccuracy in NMR resolution, or inaccuracy in GPC standards. This clearly proves that there are substantial amounts of alcohol end groups present. Additionally the GPC showed a slight increase in molecular weight when the PS-OH is compared with a PS aliquot (FIG. 7).

Macro-Initiator Functionality

In order to place the macro-initiator functionality onto the polymer 1 g of polymer was dissolved in THF and 10 eq of DCC were added along with a catalytic (0.1 eq) amount of DMAP. Finally, 4,4′-Axobis(4-cyanovaleric acid) (10 eq) was added and the solution was allowed to stir for 20 hours. The reaction was then immediately used for the next reaction.

Macro-CTA Functionality

Bis dithioate (10.1 eq) was added to the reaction above. The reaction was then bubbled with argon and heated to 80° C. for 20 hours. Upon completion of the reaction the solution was precipitated into methanol and polymer was dried under vacuum.

Block Copolymer of Macro-CTA

0.1 g of PS-D-CTA, 1 g of toluene, 0.4 g of butyl acrylate, and 0.000492 g of AIBN were added to a flask and purged for ten minutes. The flask was then heated to 80° C. for an hour. Upon completion of the reaction, the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yields the conversion.

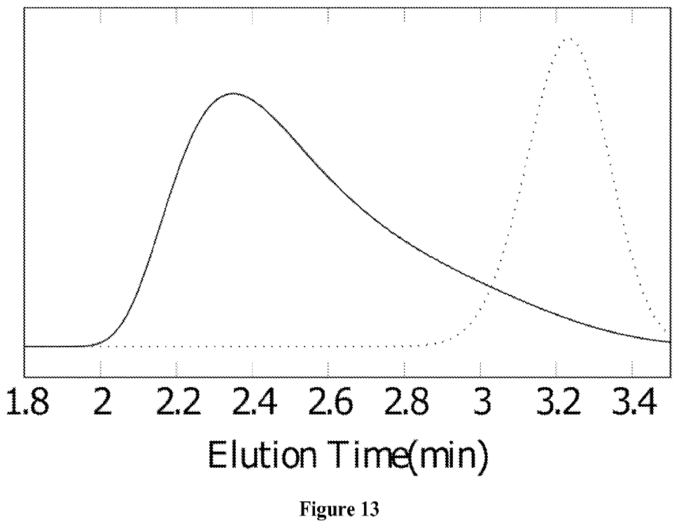

The success of the macromonomer to macro CTA conversion was determined by co-blocking styrene with NBA and comparing the integration of the grown polymer to the integration of the non-grown polymer. This allowed for the calculation of end-capping efficiency. 64% conversion was achieved as shown in FIG. 13.

### Example 8—Production of Macro-CTA Using Macroinitiator Method with Direct Reaction of Living Anion with 1,1′-Azobis(cyclohexanecarbonitrile) (ACHN)

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passing through an activated alumina column. HPLC grade cyclohexane (CHX) was purchased from Fisher Scientific and purified by inerting with argon and then passing through an oxygen scavenging column (Engelhard q5) and an activated alumina column.

Cyclohexane (500 mL) was added to an argon-filled round bottom flask equipped with a stir bar. The flask was then heated to 40° C. in a water bath. 4.5 mL of sec-butyllithium solution (targeting an 8 kDa polymer) was added. 50 grams of styrene was introduced slowly over the course of 30 minutes to limit the temperature increase due to the exothermic nature of the polymerization. Finally, an aliquot was taken in order to determine the molecular weight of the polymer prior to further modification. The aliquot when processed by the GPC showed a molecular weight of 10 kDa.

Macro-Initiator Functionality

To the living styrene above, an excess of ACHN (the exact amount was not known as it was a saturated solution of ACHN in cyclohexane was added until the color no longer changed (the color changed from a dark orange to a light yellow)). Upon completion of the reaction, the material was mixed with acidic water and precipitated into methanol. The product was collected and then dried under vacuum. GPC was run on the material to determine molecular weight. The GPC showed a coupling peak which could be from a number of sources, ideally from attack of the nitrile functionality on the ACHN.

Macro-CTA Functionality

To the reaction above was added 10 eq of bis trithioate. The reaction was then bubbled with argon and heated to 80° C. for 20 hours. Upon completion of the reaction, the solution was precipitated into methanol and polymer was dried under vacuum. The GPC showed the same coupling peak indicating that the coupling from the previous reaction was either due to oxygen, or multiple attacks on the ACHN. It was known that the azo group can be attacked.

Block Copolymer of Macro-CTA

0.1 g of PS-D-CTA, 1 g of toluene, 0.4 g of butyl acrylate, and 0.000492 g of AIBN were added to a flask and purged for ten minutes. The flask was then heated to 80° C. for an hour. Upon completion of the reaction, the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yields the conversion.

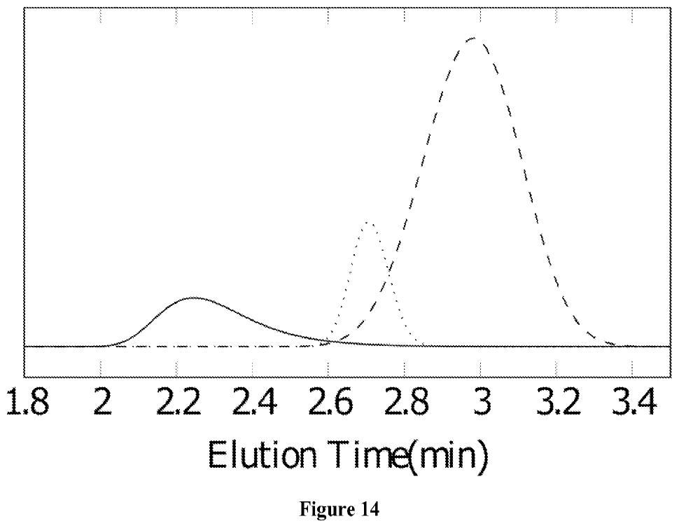

The success of the macromonomer to macro CTA was determined by co-blocking styrene with NBA and comparing the integration of the grown polymer to the integration of the non-grown polymer. This allowed for the calculation of end-capping efficiency and achieved 12% capping efficiency as shown in FIG. 14. It is believed that there are a number of ways that this method can be improved. First, ACHN does not have high solubility in cyclohexane and so switching to a more polar solvent, such as diethyl ether, should help with solubility. Secondly, it was well known that in non-polar media living styrene chains like to aggregate together (somewhere between 3-4 chains). This leads to a localized increase in concentration of chain ends. This is disadvantageous as the overall system is quite dilute. This means that if a chain in an aggregate attacks the nitrile, it is less likely to find another ACHN molecule and more likely to find the azo functionality on the molecule that it has already reacted with. This can be overcome by doing two things. Firstly, prevent the aggregation of chains. This can be accomplished by reacting the system in diethyl ether. Secondly, changing the order of addition will decrease the concentration of living chain ends at any given point leading to a likely decrease in multiple attacks of the ACHN.

### Example 9—Production of Macro-CTA Using 1,3-Dithiolane-2-thione

Polymerization of Styrene

Styrene was polymerized with commonly used procedures. Styrene and sec-butyllithium were purchased from Sigma Aldrich. Sec-butyllithium (1.4M in cyclohexane) is used as received. Styrene was purified by inerting with argon and passage through an activated alumina column. HPLC grade cyclohexane (CHX) was purchased from Fisher Scientific and purified by inerting with argon and then passing through an oxygen scavenging column (Engelhard q5) and an activated alumina column.

Cyclohexane (500 mL) was added to an argon-filled round bottom flask equipped with a stir bar. The flask was then heated to 40° C. in a water bath. 4.5 mL of sec-butyllithium solution (targeting an 8 kDa polymer) was added. 50 grams of styrene was introduced slowly over the course of 30 minutes to limit the temperature increase due to the exothermic nature of the polymerization. Finally, an aliquot was taken in order to determine the molecular weight of the polymer prior to further modification. The aliquot, when processed by the GPC, showed a molecular weight of 10 kDa.

Macro-CTA Functionality

To the reaction above was added 10 eq of 1,3-dithiolane-2-thione. After stirring for 2 hours, methyl iodide was added. The reaction was then precipitated in methanol and GPC was run. The GPC showed a clear doubling peak. The exact method of doubling is currently unknown; however, it was likely due to a second attack on the anion that was formed to form a dianion species. It is believed that polarity plays a very important role in this reaction. When using the model system of N-butyl lithium, almost none of the desired product was formed when using cyclohexane. When diethyl ether was used, better results, but still less than ideal, were achieved. Finally, when dimethoxyethane was used, more than 80% of the desired material was obtained. As living polystyrene is not soluble and not stable for long times in dimethoxyethane (at room temperature or above), a predominately polar solution was not produced.

Block Copolymer of Macro-CTA

0.1 g of PS-T-CTA, 1 g of toluene, 0.4 g of butyl acrylate, and 0.000492 g of AIBN were added to a flask and purged for ten minutes. The flask was then heated to 80° C. for an hour. Upon completion of the reaction the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yielded the conversion.

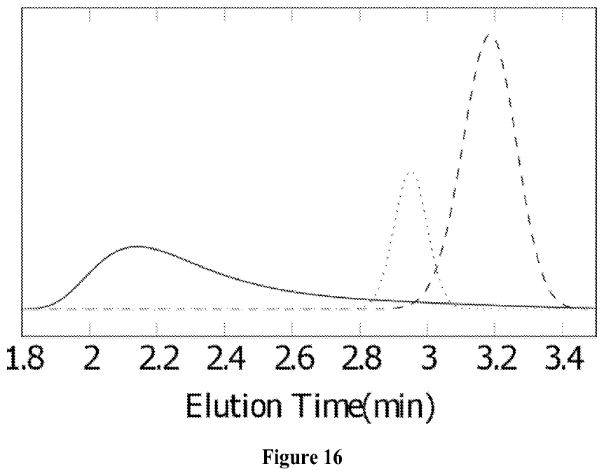

The success of the macromonomer to macro CTA was determined by co-blocking styrene with NBA and comparing the integration of the grown polymer to the integration of the non-grown polymer. This allowed for the calculation of end-capping efficiency. The achievement of 30% capping, as shown in FIG. 16, can be improved this using the methods mentioned above.

### Example 10—Production of Macro-CTA Using Pre-Built CTA Using DCC Coupling

Polymerization of Styrene

Styrene was polymerized with commonly used procedures. Styrene and sec-butyllithium were purchased from Sigma Aldrich. Sec-butyllithium (1.4M in cyclohexane) was used as received. Styrene was purified by inerting with argon and passing through an activated alumina column. HPLC grade cyclohexane (CHX) was purchased from Fisher Scientific and purified by inerting with argon and then passing through an oxygen scavenging column (Engelhard q5) and an activated alumina column.

Cyclohexane (500 mL) was added to an argon-filled round bottom flask equipped with a stir bar. The flask was then heated to 40° C. in a water bath. 4.5 mL of sec-butyllithium solution (targeting an 8 kDa polymer) was added. 50 grams of styrene was introduced slowly over the course of 30 minutes to limit the temperature increase due to the exothermic nature of the polymerization. Finally, an aliquot was taken in order to determine the molecular weight of the polymer prior to further modification. The aliquot when processed by the GPC shows a molecular weight of 10 kDa.

Ethylene Oxide Capping

Next, while the styrene was still living, ethylene oxide was used to provide a primary alcohol at the end of the styrene chain. This was done according to established procedures (Epps T. H., “Locating Network Phases in Linear ABC Triblock Copolymers,” University of Minnesota, Thesis (2004), which is hereby incorporated by reference in its entirety). Ethylene oxide (EO) was purchased from Sigma Aldrich and triple purified: The ethylene oxide (minimum of 10 molar excess with respect to sec-butyllithium) was first distilled from its original storage vessel and transferred onto calcium hydride for a minimum of half an hour to remove moisture. EO was then distilled onto approximately 0.02 eq. of di-n-butylmagnesium and allowed to stir for a minimum of a half an hour, prior to transfer to a sealed buret. The purified EO was connected to the living PS− solution via a cannula, allowing its vapor phase diffusion to the living styrene solution. The reaction was allowed to proceed for a minimum of two hours and was then terminated with acidic methanol (1 mL fuming HCl/10 mL of methanol).

The PS-OH solution was repeatedly washed with saturated sodium bicarbonate solution and distilled water pH neutral. The polymer was recovered by precipitation in methanol and washed until material becomes brittle and easily broken by impact with a spatula. The material was then dried under vacuum until all traces of cyclohexane and methanol have been removed. GPC analysis was used to determine the molecular weight distribution.

NMR was used to determine a rough estimate of the number of chains that have been capped with ethylene oxide. Comparing the integration of I_{OH}≡∫_{3.0}^{3.5} S(δ)dδ to the integration of I_{Ar}≡∫_{6.2}^{7.4} S(δ) dδ one could determine the number of protons adjacent to the alcohol and the number of protons on the aromatic repeat unit (FIG. 4). Setting the protons adjacent to the alcohol to one gives conversion via the following formula.

$$\frac{{PS}_{molweight}}{{\int }_{6.2}^{7.4} S ( δ ) d δ * \frac{protons adjacent to Hydroxyl}{aromatic protons} * Mn Styrene} = \frac{10000}{181 * \frac{2}{5} * 104} = 132 \%$$

This higher than 100% conversion result can be attributed to two factors: inaccuracy in NMR resolution, or inaccuracy in GPC standards. This clearly proves that there are substantial amounts of alcohol end groups present. Additionally the GPC shows a slight increase in molecular weight when the PS-OH is compared with a PS aliquot (FIG. 7).

Macro-CTA Functionality

To 1 g of ethylene oxide capped polystyrene was added THF, 10 eq of DCC 0.1 eq of DMAP, and 10 eq of 2-(((ethylthio)carbonothioyl)thio)-2-methylpropanoic acid. The reaction was carried out by heating to 40° C. and stirring for 20 hours before precipitating the polymer in methanol.

Block Copolymer of Macro-CTA

0.1 g of PS-T-CTA, 1 g of toluene, 0.4 g of butyl acrylate, and 0.000492 g of AIBN were added to a flask and purged for ten minutes. The flask was then heated to 80° C. for an hour. Upon completion of the reaction the polymer was dried down under high vacuum to remove toluene and unreacted butyl acrylate. The polymer was then run under GPC in order to determine the percent cross-over from PS to PS-CTA. This was done by integrating the UV signal of the grown polymer peak and integrating the residual original polymer peak. The ratio of the two yielded the conversion.

The success of the macromonomer to macro CTA was determined by co-blocking styrene with NBA and comparing the integration of the grown polymer to the integration of the non-grown polymer. This allowed for the calculation of end-capping efficiency. 95% conversion was achieved.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A compound of Formula (I): 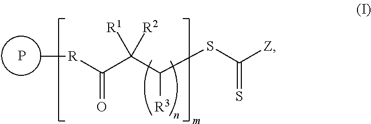
wherein
m is 0 or 1;
n is 0 or 30; 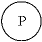
is a polymer;
R is —O—, —C₁₋₃₀ alkylene-O—, or carbon linkage;
R¹ is H or C₁₋₃₀ alkyl;
R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;
p is 0, 1, or 2; and
Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl.

2. The compound of claim 1, wherein the compound of Formula (I) has the structure of Formula (Ia)-(Ie): 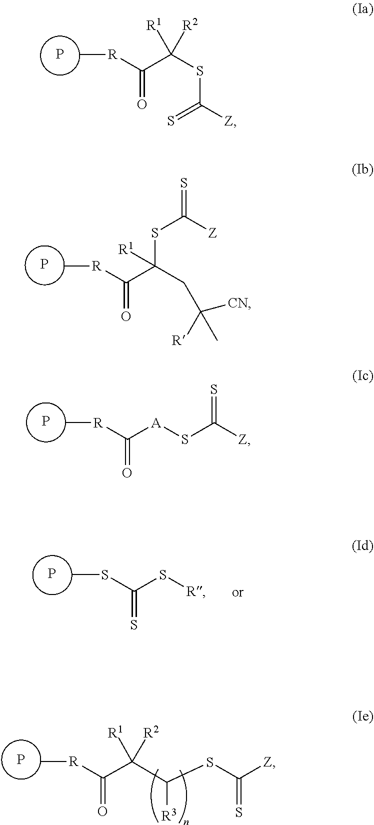
wherein
A is C₁₋₃₀ alkylene optionally substituted from 1 to 4 times with a substituent selected independently at each occurrence thereof from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b};
R′ is C₁₋₃₀ alkyl;
R″ is selected from the group consisting of C₁₋₃₀ alkyl, —OC₁₋₆ alkyl, —SC₁₋₆ alkyl, —O-aryl, —N(C₁₋₆ alkyl)₂, —N(aryl)(C₁₋₆ alkyl), aryl, heteroaryl, and heterocyclyl, wherein each of C₁₋₃₀ alkyl, aryl, heteroaryl, and heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl; and
p is 0, 1, or 2.

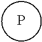

3. The compound of claim 1, wherein is polystyrene, polybutadiene, or polyisoprene.

4. A compound of Formula (II): 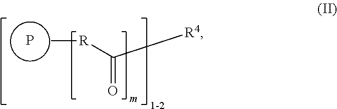
wherein
m is 0 or 1; 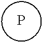
is a polymer;
R is —O—, —C₁₋₃₀ alkylene-O—, or carbon linkage;
R⁴ is absent or selected from the group consisting of 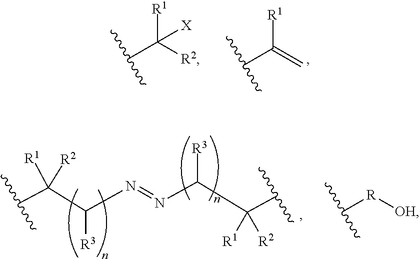
X is halogen;
n is 0 or 30;
R¹ is H or C₁₋₃₀ alkyl;
R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —R^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;
p is 0, 1, or 2.

5. The compound of claim 4, wherein the compound of Formula (II) has the structure of Formula (IIa)-(IIe):

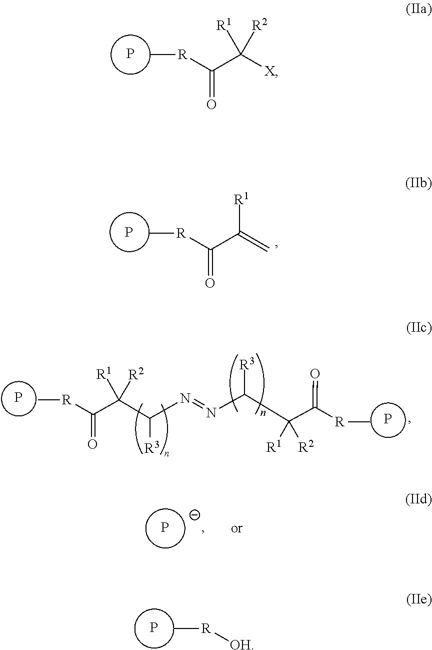

6. The compound of claim 4, wherein 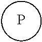
is polystyrene, polybutadiene, or polyisoprene.

7. A process for preparation of a compound of Formula (I): 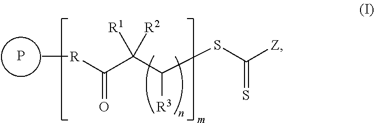
wherein
m is 0 or 1;
n is 0 to 30; 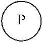
is a polymer;
R is —O—, —C₁₋₃₀ alkylene-O—, or carbon linkage;
R¹ is H or C₁₋₃₀ alkyl;
R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;
p is 0, 1, or 2; and
Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl,
said process comprising:
providing a compound of Formula (II): 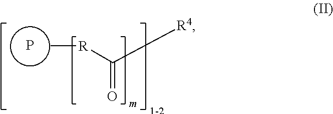
wherein
R⁴ is absent or selected from the group consisting of R 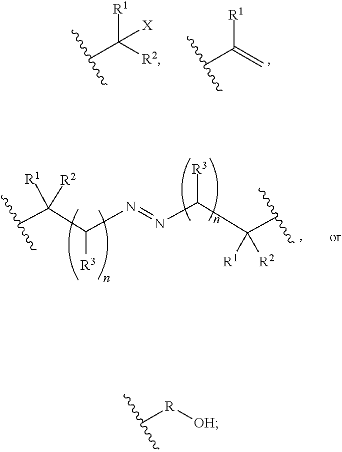
X is halogen,
and
forming the compound of Formula (I) from compound of Formula (II).

8. The process according to claim 7, wherein the compound of Formula (I) has the structure of Formula (Ia)-(Ie): 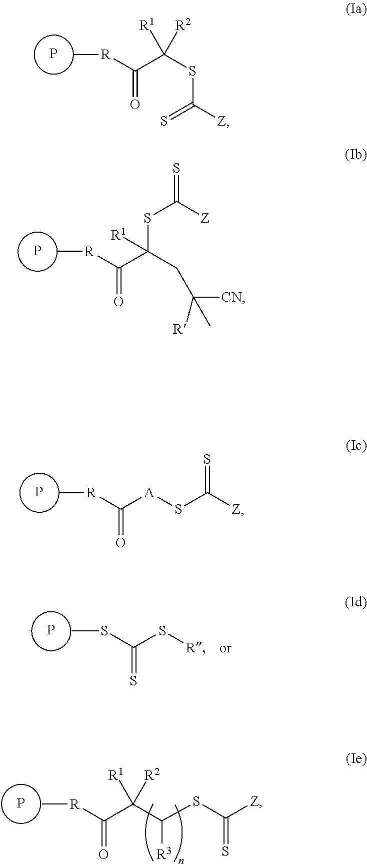
wherein
A is C₁₋₃₀ alkylene optionally substituted from 1 to 4 times with a substituent selected independently at each occurrence thereof from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b};
R′ is C₁₋₃₀ alkyl;
R″ is selected from the group consisting of C₁₋₃₀ alkyl, —OC₁₋₆ alkyl, —SC₁₋₆ alkyl, —O-aryl, —N(C₁₋₆ alkyl)₂, —N(aryl)(C₁₋₆ alkyl), aryl, heteroaryl, and heterocyclyl, wherein each of C₁₋₃₀ alkyl, aryl, heteroaryl, and heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl; and
p is 0, 1, or 2.

9. The process according to claim 7, wherein 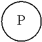
is polystyrene,
polybutadiene, or polyisoprene.

10. The process according to claim 7, wherein the compound of Formula (II) has the structure of Formula (IIa)-(IIe):

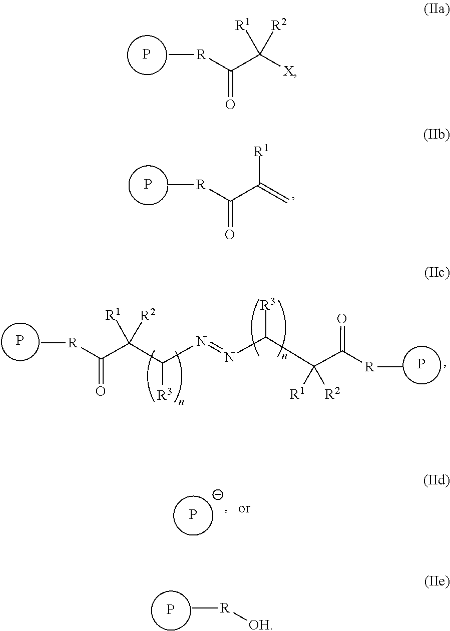

11. The process according to claim 7, wherein 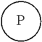
is a polymer prepared by polymerization of styrene, butadiene, isoprene, hexamethyl(cyclotrisiloxane), butylene oxide, propylene oxide, ethylene oxide, or a mixture thereof.

12. The process according to claim 7, wherein said forming the compound of Formula (I) comprises reacting the compound of Formula (II) with a compound of Formula (III): 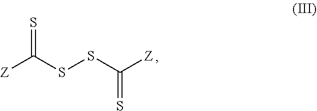
under conditions effective to produce the compound of Formula (I).

13. The process according to claim 12, wherein the compound of Formula (II) has the Formula (IIa):

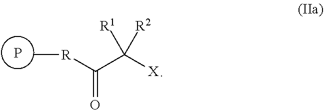

14. The process according to claim 13, wherein the compound of Formula (IIa) is prepared by a process comprising:
providing compound of Formula (IIe): 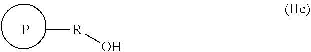
and
forming the compound of Formula (IIa) from compound of Formula (IIe).

15. The process according to claim 14, wherein said forming the compound of Formula (IIa) comprises:
reacting the compound of Formula (IIe) with a compound of Formula (IV): 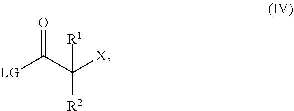
wherein LG is a suitable leaving group;
under conditions effective to produce the compound of Formula (IIa).

16. The process according to claim 15, wherein the suitable leaving group is selected from the group consisting of OH, halogen, and

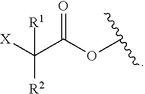

17. The process according to claim 14, wherein the compound of Formula (IIe) is prepared by a process comprising:
providing a compound of Formula (IId): 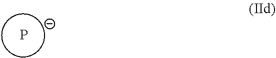
and
forming the compound of Formula (IIe) from the compound of Formula (IId).

18. The process according to claim 17, wherein said forming the compound of Formula (IIe) comprises:
reacting the compound of Formula (IId) with an alcohol or an epoxide under conditions effective to produce the compound of Formula (IIe).

19. The process according to claim 13, wherein the compound of Formula (IIa) is prepared by a process comprising:
providing a compound of Formula (IId): 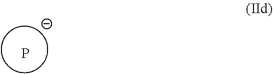
and
forming the compound of Formula (IIa) from the compound of Formula (IId).

20. The process according to claim 19, wherein said forming the compound of Formula (IIa) comprises:
reacting the compound of Formula (IId) with a compound of Formula (IVa): 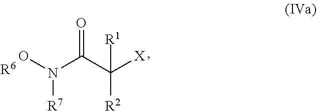
wherein R⁶ and R⁷ are each independently H or C₁₋₆ alkyl,
under conditions effective to produce the compound of Formula (II).

21. The process according to claim 7, wherein said forming the compound of Formula (I) comprises:
reacting the compound of Formula (II) with a compound of Formula (V): 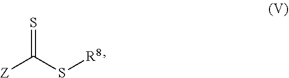
wherein R⁸ is C₁₋₃₀ alkyl optionally substituted from 1 to 4 times with a substituent selected independently at each occurrence thereof from the group consisting of C₁₋₃₀ alkyl, —CN, aryl, and —COOC₁₋₆ alkyl,
under conditions effective to produce the compound of Formula (I).

22. The process according to claim 21, wherein the compound of Formula (II) is compound of Formula (lib):

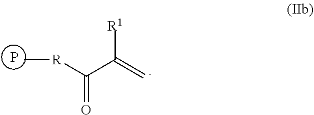

23. The process according to claim 22, wherein the compound of Formula (IIb) is prepared by a process comprising:
providing compound of Formula (IIe): 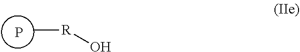
and
forming the compound of Formula (IIb) from compound of Formula (IIe).

24. The process according to claim 23, wherein said forming the compound of Formula (IIb) comprises
reacting the compound of Formula (IIe) with a compound of Formula (VI): 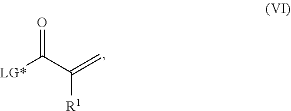
wherein LG* is a suitable leaving group;
under conditions effective to produce the compound of Formula (IIb).

25. The process according to claim 24, wherein the suitable leaving group is selected from the group consisting of OH, halogen, and

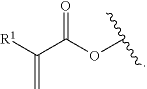

26. The process according to claim 23, wherein the compound of Formula (IIe) is prepared by a process comprising:
providing a compound of Formula (IId): 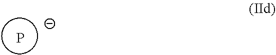
and
forming the compound of Formula (IIe) from the compound of Formula (IId).

27. The process according to claim 26, wherein said forming the compound of Formula (IIe) comprises:
reacting the compound of Formula (IId) with an alcohol or an epoxide under conditions effective to produce the compound of Formula (IIe).

28. The process according to claim 22, wherein the compound of Formula (IIb) is prepared by a process comprising:
providing a compound of Formula (IId): 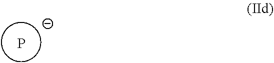
and
forming the compound of Formula (IIb) from the compound of Formula (IId).

29. The process according to claim 28, wherein said forming the compound of Formula (IIb) comprises:
reacting the compound of Formula (IId) with a compound of Formula (VIa): 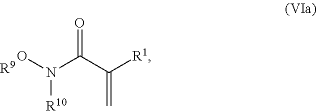
wherein R⁹ and R¹⁰ are each independently H or C₁₋₆ alkyl,
under conditions effective to produce the compound of Formula (IIb).

30. The process according to claim 12, wherein the compound of Formula (II) has the Formula (IIc):

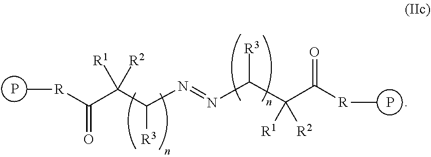

31. The process according to claim 30, wherein the compound of Formula (IIc) is prepared by a process comprising:
providing a compound of Formula (IIe): 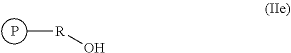
and
reacting the compound of Formula (IIe) with a compound of Formula (VII): 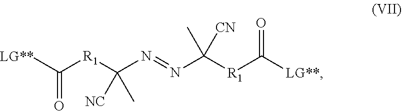
wherein LG** is a suitable leaving group;
under conditions effective to produce the compound of Formula (IIc).

32. The process according to claim 31, wherein the suitable leaving group is selected from the group consisting of OH, halogen, and

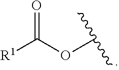

33. The process according to claim 31, wherein the compound of Formula (IIe) is prepared by a process comprising:
providing a compound of Formula (IId): 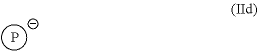
and
forming the compound of Formula (IIe) from the compound of Formula (IId).

34. The process according to claim 33, wherein said forming the compound of Formula (IIe) comprises:
reacting the compound of Formula (IId) with an alcohol or an epoxide under conditions effective to produce the compound of Formula (IIe).

35. The process according to claim 30, wherein the compound of Formula (IIc) is prepared by a process comprising:
providing a compound of Formula (IId): 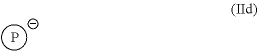
and
reacting the compound of Formula (IId) with a compound of Formula (VIIa): 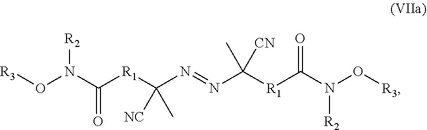
under conditions effective to produce the compound of Formula (IIc).

36. The process according to claim 30, wherein the compound of Formula (IIc) is prepared by a process comprising:
providing a compound of Formula (IId): 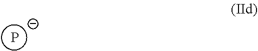
and
reacting the compound of Formula (IIe) with a compound of Formula (VIII): 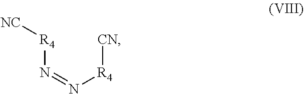
wherein R₄ is C₁₋₆ alkylene or C₃₋₈ cycloalkylene, wherein C₁₋₆ alkylene or C₃₋₈ cycloalkylene can be optionally substituted from 1 to 4 times with C₁₋₃₀ alkyl;
under conditions effective to produce the compound of Formula (IIc).

37. The process according to claim 7, wherein said forming the compound of Formula (I) comprises:
reacting the first intermediate compound of Formula (IId) with a compound of Formula: 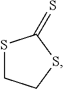
under conditions effective to produce the compound of Formula (I).

38. The process according to claim 7, wherein said forming the compound of Formula (I) comprises:
reacting the first intermediate compound of Formula (IIe) with a compound of Formula (VI): 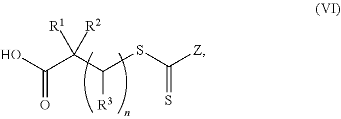
under conditions effective to produce the compound of Formula (I).

39. The process according to claim 38, wherein the compound of Formula (IIe) is prepared by a process comprising:
providing a compound of Formula (IId): 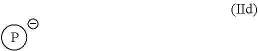
and
forming the compound of Formula (IIe) from the compound of Formula (IId).

40. The process according to claim 39, wherein said forming the compound of Formula (IIe) comprises:
reacting the compound of Formula (IId) with an alcohol or an epoxide under conditions effective to produce the compound of Formula (IIe).

41. A process for preparation of a compound of Formula (IIa): 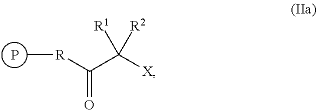
wherein 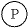
is a polymer;
R is —O—, —C₁₋₃₀ alkylene-O—, or carbon linkage;
R¹ is H or C₁₋₃₀ alkyl;
R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;
p is 0, 1, or 2; and
X is halogen,
said process comprising:
providing a compound of Formula (IId): 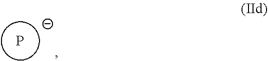
and
forming the compound of Formula (IIa) from compound of Formula (IId).

42. The process according to claim 41, wherein said forming the compound of Formula (IIa) comprises:
reacting the compound of Formula (IId) with a compound of Formula (IVa): 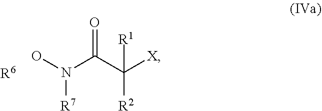
wherein R⁶ and R⁷ are each independently H or C₁₋₆ alkyl,
under conditions effective to produce the compound of Formula (IIa).

43. A process for preparation of a compound of Formula (IIb): 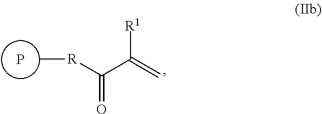
wherein 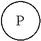
is a polymer;
R is —O—, —C₁₋₃₀ alkylene-O—, or carbon linkage;
R¹ is H or C₁₋₃₀ alkyl;
said process comprising:
providing a compound of Formula (IId): 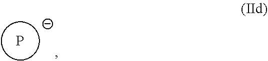
and
forming the compound of Formula (IIb) from compound of Formula (IId).

44. The process according to claim 43, wherein said forming the compound of Formula (IIb) comprises:
reacting the compound of Formula (IId) with a compound of Formula (VIa): 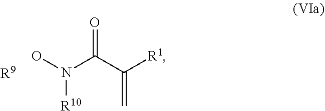
wherein R⁹ and R¹⁰ are each independently H or C₁₋₆ alkyl,
under conditions effective to produce the compound of Formula (IIb).

45. A process for preparation of a compound of Formula (IIc): 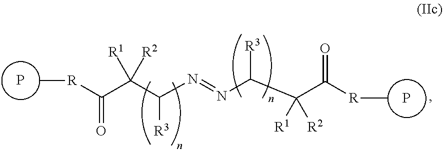
wherein 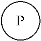
is a polymer;
n is 0 to 30;
R is —O—, —C₁₋₃₀ alkylene-O—, or carbon linkage;
R¹ is H or C₁₋₃₀ alkyl;
R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and CN;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;
p is 0, 1, or 2; and
said process comprising:
providing a compound of Formula (IId): 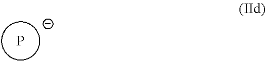
and
forming the compound of Formula (IIc) from compound of Formula (IId).

46. The process according to claim 45, wherein said forming the compound of Formula (IIc) comprises:
reacting the compound of Formula (IId) with a compound of Formula (VIIa): 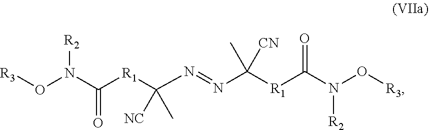
under conditions effective to produce the compound of Formula (IIc).

47. A process for the synthesis of a polymer comprising:
providing a monomer composition;
providing a compound of Formula (I): 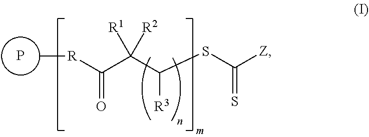
wherein
m is 0 or 1;
n is 0 or 30; 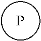
is a polymer;
R is —O—, —C₁₋₃₀ alkylene-O—, or carbon linkage;
R¹ is H or C₁₋₃₀ alkyl;
R² is selected from the group consisting of H, C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R³ is selected from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b}, wherein C₁₋₃₀ alkyl can be optionally substituted from 1 to 4 times with a substituent selected independently at each occurrence thereof from the group consisting of C₁₋₃₀ alkyl and —CN;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl;
p is 0, 1, or 2; and
Z is selected from the group consisting of —S—C₁₋₃₀ alkyl, —S—OC₁₋₆ alkyl, —S—SC₁₋₆ alkyl, —S—O-aryl, —S—N(C₁₋₆ alkyl)₂, —S—N(aryl)(C₁₋₆ alkyl), —S-aryl, —S-heteroaryl, —S— heterocyclyl, Ph, —OC₁₋₃₀ alkyl, heterocyclyl, and phosphate, wherein each of —S—C₁₋₃₀ alkyl, —S-aryl, —S-heteroaryl, and —S-heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl, and
polymerizing monomers within the monomer composition through controlled free radical polymerization with the compound of Formula (I) to form the polymer.

48. The process of claim 47, wherein the compound of Formula (I) has the structure of Formula (Ia)-(Ie): 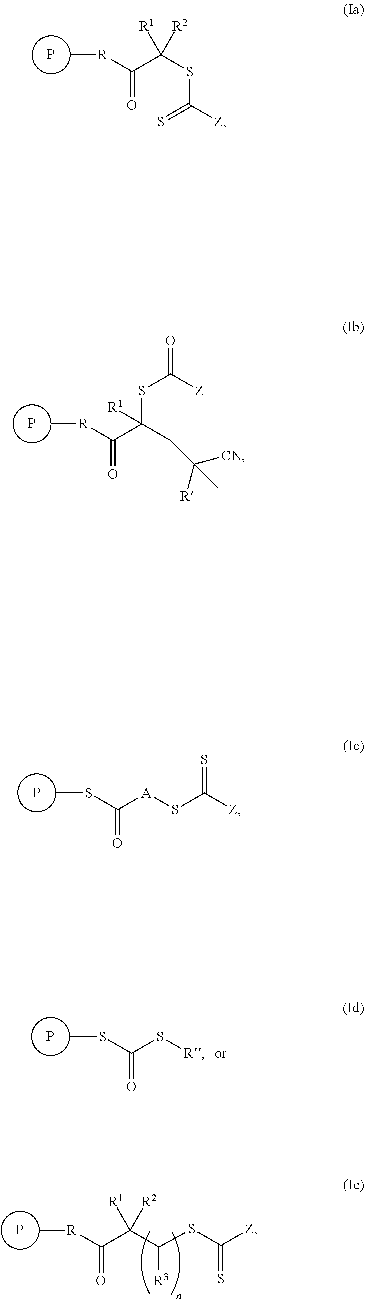
wherein
A is C₁₋₃₀ alkylene optionally substituted from 1 to 4 times with a substituent selected independently at each occurrence thereof from the group consisting of C₁₋₃₀ alkyl, C₂-C₃₀ alkenyl, C₂-C₃₀ alkynyl, C₃₋₆ cycloalkyl, C₄₋₃₀ cycloalkylalkyl, —CN, halogen, —NO₂, —OR^{a}, —NR^{a}R^{b}, —C(O)₂R^{b}, —NR^{a}C(O)₂R^{b}, —NR^{a}C(O)NR^{a}R^{b}, —S(O)ₚR^{b}, and —C(O)R^{b};
R′ is C₁₋₃₀ alkyl;
R″ is selected from the group consisting of C₁₋₃₀ alkyl, —OC₁₋₆ alkyl, —SC₁₋₆ alkyl, —O-aryl, —N(C₁₋₆ alkyl)₂, —N(aryl)(C₁₋₆ alkyl), aryl, heteroaryl, and heterocyclyl, wherein each of C₁₋₃₀ alkyl, aryl, heteroaryl, and heterocyclyl can be optionally substituted from 1 to 4 times with a substituent selected independently at each occurrence thereof from the group consisting of C₁₋₃₀ alkyl, ═O, —CN, aryl, and —COOC₁₋₆ alkyl;
R^{a} is independently in each occurrence selected from the group consisting of H, C₁₋₄ alkyl, C₃₋₆ cycloalkyl, C₄₋₇ cycloalkylalkyl, —C(O)R^{b}, phenyl, and benzyl, wherein phenyl or benzyl is optionally substituted 1 to 3 times with halogen, —CN, C₁₋₄ alkyl, or —OC₁₋₄ alkyl;
R^{b} is independently in each occurrence selected from the group consisting of H, C₁₋₄ alkyl, C₃₋₆ cycloalkyl, C₄₋₇ cycloalkylalkyl, phenyl, and benzyl, wherein phenyl or benzyl is optionally substituted 1 to 3 times with halogen, —CN, C₁₋₄ alkyl, or —OC₁₋₄ alkyl; and
p is 0, 1, or 2.

49. The process of claim 47, wherein 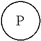
is polystyrene, polybutadiene, or polyisoprene.

50. The process according to claim 47, wherein 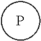
is a polymer prepared by polymerization of styrene, butadiene, isoprene, hexamethyl(cyclotrisiloxane), butylene oxide, propylene oxide, ethylene oxide, or a mixture thereof.

51. The process of claim 47, wherein said monomer composition comprises one or more types of monomers.

52. The process of claim 51, wherein the one or more types of monomers is selected from the group consisting of vinyl aromatic monomers and acrylate monomers.

53. The process of claim 51, wherein the one or more types of monomers is selected from the group consisting of styrene, butyl acrylate, methyl acrylate, and methyl methacrylate.

54. The process of claim 47, wherein said polymerizing is carried out by reversible addition-fragmentation chain-transfer polymerization (RAFT), in the presence of a free radical initiator and a solvent.

55. The method of claim 54, wherein said polymerizing is carried out at a temperature of 10 to 160° C.

56. The method of claim 54, wherein said solvent is selected from the group consisting of toluene, THF, chloroform, cyclohexane, dioxane, dimethyl sulfoxide, dimethyl formamide, acetone, acetonitrile, n-butanol, n-pentanol, chlorobenzene, dichloromethane, diethylether, tert-butanol, 1,2,-dichloroethylene, diisopropylether, ethanol, ethylacetate, ethylmethylketone, heptane, hexane, isopropylalcohol, isoamylalcohol, methanol, pentane, n-propylalcohol, pentachloroethane, 1,1,2,2,-tetrachloroethane, 1,1,1,-trichloroethane, tetrachloroethylene, tetrachloromethane, trichloroethylene, water, xylene, benzene, nitromethane, glycerol, and a mixture thereof.

57. The method of claim 54, wherein said solvent is methanol, glycerol, or a mixture thereof.

58. The method of claim 54, wherein the free radical initiator is selected from the group consisting of benzoyl peroxide, 4,4-azobis(4-cyanovaleric acid), azo-biscyclohexanecarbonitrile, bis(tert-butylperoxy)butane, 1,1-bis(tert-butylperoxy)cyclohexane, 1,1-bis(tert-butylperoxy)-3,3,5-trimethylcyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 1 2,4-pentanedione peroxide, peracetic acid, potassium persulfate, and azobisisobutyronitrile.

59. The process of claim 47, wherein said polymerizing is carried out to produce a homopolymer, copolymer, or block copolymer having a linear or branched-chain structure.
